(19) United States
(12) Patent Application Publication
(10) Pub. No.: US 2022/0373768 A1
(43) Pub. Date: Nov. 24, 2022

(54) OPTICAL SYSTEM, OPTICAL APPARATUS, AND METHOD FOR MANUFACTURING OPTICAL SYSTEM

(71) Applicant: Nikon Corporation, Minato-ku, Tokyo (JP)

(72) Inventor: Takamichi KURASHIGE, Funabashi-shi (JP)

(21) Appl. No.: 17/762,052

(22) PCT Filed: Sep. 3, 2020
(86) PCT No.: PCT/JP2020/033364

§ 371 Date: Mar. 19, 2022

(30) Foreign Application Priority Data
Sep. 30, 2019 (JP) 2019-178381
Sep. 30, 2019 (JP) 2019-178382
Sep. 30, 2019 (JP) 2019-178383

(51) Int. Cl. G02B 9/64; G02B 13/06; G02B 13/00

(52) U.S. Cl. CPC G02B 9/64; G02B 13/06; G02B 13/006

(57) ABSTRACT

An optical system and an optical apparatus that have a wide angle of view and favorable optical performance and a method for manufacturing the optical system are provided. An optical system OL used for an optical apparatus such as a camera 1 includes, sequentially from an object side, a first lens group G1, an aperture stop S, and a second lens group G2, first lens group G1 includes, sequentially from the object side, at least two negative lenses (for example, negative lenses L1n1 and L1n2), a positive lens (for example, a positive lens L1p1), and a back-side negative lens (for example, a negative lens L1nr), and the optical system OL satisfies a condition expressed by a predetermined conditional expression.

### TECHNICAL FIELD

The present invention relates to an optical system, an optical apparatus, and a method for manufacturing the optical system.

### BACKGROUND ART

Conventionally, an optical system that achieves a wide angle of view has been disclosed (refer to Patent Literature 1, for example). However, further improvement of optical performance is required for Patent Literature 1.

### CITATION LIST

### Patent Literature

Patent Literature 1: Japanese Patent Laid-open No. 09-127412

### SUMMARY OF INVENTION

An optical system according to a first aspect of the present invention includes, sequentially from an object side, a first lens group, an aperture stop, and a second lens group, the first lens group includes, sequentially from the object side, at least two negative lenses, a positive lens, and a back-side negative lens, and the optical system satisfies a condition expressed by an expression below,

90.00°<ωmax

in the expression,

ωmax: maximum value [°] of a half angle of view of the optical system.

An optical system according to a second aspect of the present invention includes, sequentially from an object side, a first lens group, an aperture stop, and a second lens group, the first lens group includes, sequentially from the object side, at least two negative lenses, a positive lens, and a back-side negative lens, and the optical system satisfies a condition expressed by an expression below,

0.300<(−f1)/θmax<9.200
in the expression,
f1: focal length of the first lens group, and
θmax: maximum value [radian] of a half angle of view of the optical system.

An optical system according to a third aspect of the present invention includes, sequentially from an object side, a first lens group, an aperture stop, and a second lens group, the first lens group includes, sequentially from the object side, at least two negative lenses, a positive lens, and a back-side negative lens, and the optical system satisfies a condition expressed by an expression below,

0.280<D12/(−f1)<1.200

in the expression,

D12: distance on an optical axis between two negative lenses disposed closest to the object side in the first lens group, and

f1: focal length of the first lens group.

A method for manufacturing the optical system according to the first aspect of the present invention is a method for manufacturing an optical system including, sequentially from an object side, a first lens group, an aperture stop, and a second lens group, the method for manufacturing the optical system including: a step of disposing sequentially from the object side, at least two negative lenses, a positive lens, and a back-side negative lens in the first lens group; and a step of disposing the lenses so that a condition expressed by an expression below is satisfied,

90.00°<ωmax

in the expression,

ωmax: maximum value [°] of a half angle of view of the optical system.

A method for manufacturing the optical system according to the second aspect of the present invention is a method for manufacturing an optical system including, sequentially from an object side, a first lens group, an aperture stop, and a second lens group, the method for manufacturing the optical system including: a step of disposing sequentially from the object side, at least two negative lenses, a positive lens, and a back-side negative lens in the first lens group; and a step of disposing the lenses so that a condition expressed by an expression below is satisfied,

0.300<(−f1)/θmax<9.200

in the expression,

f1: focal length of the first lens group, and

θmax: maximum value [radian] of a half angle of view of the optical system.

A method for manufacturing the optical system according to the third aspect of the present invention is a method for manufacturing an optical system including, sequentially from an object side, a first lens group, an aperture stop, and a second lens group, the method for manufacturing the optical system including: a step of disposing sequentially from the object side, at least two negative lenses, a positive lens, and a back-side negative lens in the first lens group; and a step of disposing the lenses so that a condition expressed by an expression below is satisfied,

0.280<D12/(−f1)<1.200

in the expression,

D12: distance on an optical axis between two negative lenses disposed closest to the object side in the first lens group, and

f1: focal length of the first lens group.

### BRIEF DESCRIPTION OF DRAWINGS

FIG. 1 is a cross-sectional view showing a lens configuration of an optical system according to a first example.

FIG. 2 shows a variety of aberration diagrams of the optical system according to the first example.

FIG. 3 is a cross-sectional view showing a lens configuration of an optical system according to a second example.

FIG. 4 shows a variety of aberration diagrams of the optical system according to the second example.

FIG. 5 is a cross-sectional view showing a lens configuration of an optical system according to a third example.

FIG. 6 shows a variety of aberration diagrams of the optical system according to the third example.

FIG. 7 is a cross-sectional view showing a lens configuration of an optical system according to a fourth example.

FIG. 8 shows a variety of aberration diagrams of the optical system according to the fourth example.

FIG. 9 is a cross-sectional view showing a lens configuration of an optical system according to a fifth example.

FIG. 10 shows a variety of aberration diagrams of the optical system according to the fifth example.

FIG. 11 is a cross-sectional view showing a lens configuration of an optical system according to a sixth example.

FIG. 12 shows a variety of aberration diagrams of the optical system according to the sixth example.

FIG. 13 is a cross-sectional view showing a lens configuration of an optical system according to a seventh example.

FIG. 14 shows a variety of aberration diagrams of the optical system according to the seventh example.

FIG. 15 is a cross-sectional view showing a lens configuration of an optical system according to an eighth example.

FIG. 16 shows a variety of aberration diagrams of the optical system according to the eighth example.

FIG. 17 is a cross-sectional view showing a lens configuration of an optical system according to a ninth example.

FIG. 18 shows a variety of aberration diagrams of the optical system according to the ninth example.

FIG. 19 is a cross-sectional view showing a lens configuration of an optical system according to a tenth example.

FIG. 20 shows a variety of aberration diagrams of the optical system according to the tenth example.

FIG. 21 is a cross-sectional view showing a lens configuration of an optical system according to an eleventh example.

FIG. 22 shows a variety of aberration diagrams of the optical system according to the eleventh example.

FIG. 23 is a cross-sectional view showing a lens configuration of an optical system according to a twelfth example.

FIG. 24 shows a variety of aberration diagrams of the optical system according to the twelfth example.

FIG. 25 is a cross-sectional view of a camera on which an above-described optical system is mounted.

FIG. 26 is a flowchart for description of a method for manufacturing the above-described optical system.

### DESCRIPTION OF EMBODIMENTS

Preferable embodiments will be described below with reference to the drawings.

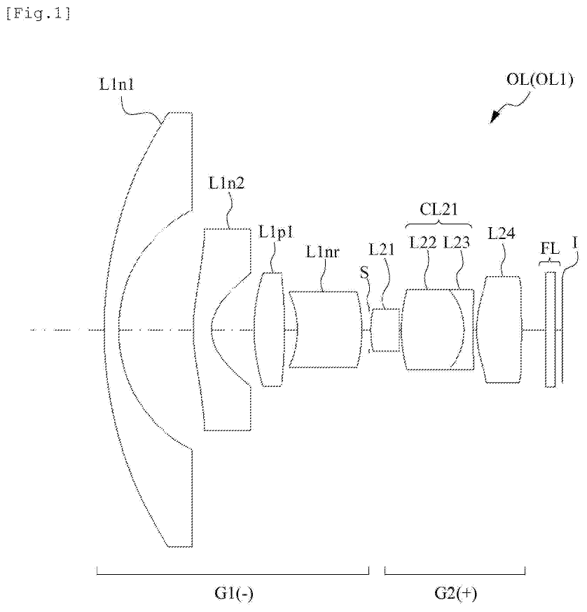

As shown in FIG. 1, an optical system OL according to the present embodiment includes, sequentially from an object side, a first lens group G1, an aperture stop S, and a second lens group G2. The first lens group G1 includes, sequentially from the object side, at least two negative lenses (for example, a negative meniscus lens L1n1 and an aspheric negative lens L1n2 in an example shown in FIG. 1), a positive lens (for example, a biconvex positive lens L1p1 in the example shown in FIG. 1; hereinafter referred to as a “first positive lens”), and an image-side negative lens (for example, a negative meniscus lens L1nr in the example shown in FIG. 1). With such a configuration, an optical system having a wide angle of view and high performance can be obtained.

The optical system OL according to the present embodiment desirably satisfies Conditional Expression (1) shown below.

90.00°<ωmax (1)

in the expression,

ωmax: maximum value [°] of a half angle of view of the optical system OL.

Conditional Expression (1) defines the maximum value of the half angle of view of the optical system OL. When Conditional Expression (1) is satisfied, the optical system OL having a wide angle of view can be obtained. When the lower limit value of Conditional Expression (1) is exceeded, the angle of view is not a wide angle of view that is desired for as an ultrawide-angle lens and thus is not preferable. Meanwhile, it is possible to secure the advantageous effect of Conditional Expression (1) more surely by setting the lower limit value of Conditional Expression (1) to 95.00°. Further, in order to secure the advantageous effect of Conditional Expression (1) more surely, it is preferable to set 97.50°, 100.00°, and more preferable to 105.00°.

The optical system OL according to the present embodiment desirably satisfies Conditional Expression (2) shown below.

0.300<(−f1)/θmax<9.200 (2)

in the expression,

f1: focal length of the first lens group G1, and

θmax: maximum value [radian] of the half angle of view of the optical system OL.

Conditional Expression (2) defines the ratio of the focal length of the first lens group relative to the maximum value of the half angle of view of the optical system OL. The relation θmax=ωmax×π/180 holds (π is the circular constant). When Conditional Expression (2) is satisfied, the optical system OL having a wide angle of view and favorable optical performance can be obtained. When the lower limit value of Conditional Expression (2) is exceeded, the refractive power (power) of the first lens group G1 is too strong for the angle of view, which degrades field curvature, and thus is not preferable. Meanwhile, it is possible to secure the advantageous effect of Conditional Expression (2) more surely by setting the lower limit value of Conditional Expression (2) to 0.500. Further, in order to secure the advantageous effect of Conditional Expression (2), it is preferable to set the lower limit value of Conditional Expression (2) to 0.600, 0.700, 0.800, 0.850, 0.900, 0.950, 1.000, 1.050, 1.100, 1.150, 1.200, 1.250, 1.300, 1.350, 1.400, and more preferable to 1.450. Moreover, when the upper limit value of Conditional Expression (2) is exceeded, the refractive power (power) of the first lens group G1 is too weak for the angle of view, which degrades field curvature, and thus such a value is not preferable. Furthermore, when the angle of view is reduced, the angle of view is not a wide angle of view that is desired for as an ultrawide-angle lens and thus such a value is not preferable. Meanwhile, it is possible to secure the advantageous effect of Conditional Expression (2) more surely by setting the upper limit value of Conditional Expression (2) to 8.500. Further, in order to secure the advantageous effect of Conditional Expression (2) more surely, it is preferable to set the upper limit value of Conditional Expression (2) to 7.500, 6.750, 6.500, 6.250, 6.000, 5.750, 5.550, 5.250, 5.000, 4.850, 4.700, 4.500, and more preferable to 4.250.

The optical system OL according to the present embodiment desirably satisfies Conditional Expression (3) shown below.

0.280<D12/(−f1)<1.200 (3)

in the expression,

D12: distance on an optical axis between the two negative lenses disposed closest to the object side in the first lens group G1, and

f1: focal length of the first lens group G1.

Conditional Expression (3) defines the ratio of the distance on the optical axis between the two negative lenses disposed closest to the object side in the first lens group G1 relative to the focal length of the first lens group G1. When Conditional Expression (3) is satisfied, it is possible to achieve favorable optical performance of the optical system OL and size reduction of the optical system OL by appropriately disposing the two negative lenses (L1n1 and L1n2) disposed closest to the object side in the first lens group G1. When the lower limit value of Conditional Expression (3) is exceeded, correction of a variety of aberrations leads to interference between the two negative lenses (L1n1 and L1n2) disposed closest to the object side in the first lens group G1 when an outer diameter is increased at manufacturing, and thus such a value is not preferable. Furthermore, it is difficult to correct field curvature, coma aberration, and lateral chromatic aberration, and thus such a value is not preferable. Meanwhile, it is possible to secure the advantageous effect of Conditional Expression (3) more surely by setting the lower limit value of Conditional Expression (3) to 0.300. Further, in order to secure the advantageous effect of Conditional Expression (3), it is preferable to set the lower limit value of Conditional Expression (3) to 0.325, 0.340, 0.355, 0.370, 0.390, 0.400, 0.420, and more preferable to 0.430. Moreover, when the upper limit value of Conditional Expression (3) is exceeded, the total length of the optical system OL is large, and thus such a value is not preferable. Furthermore, it is difficult to correct field curvature, coma aberration, and lateral chromatic aberration, and thus such a value is not preferable. Meanwhile, it is possible to secure the advantageous effect of Conditional Expression (3) more surely by setting the upper limit value of Conditional Expression (3) to 1.185. Further, in order to secure the advantageous effect of Conditional Expression (3) more surely, it is preferable to set the upper limit value of Conditional Expression (3) to 1.150, 1.125, 1.100, 1.080, 1.050, 1.025, and more preferable to 1.000.

The optical system OL according to the present embodiment desirably satisfies Conditional Expression (4) shown below.

−10.000<(Lnr1−Lpr2)/(Lnr1+Lpr2)≤0.000 (4)

in the expression,

Lpr2: radius of curvature of a lens surface of the first positive lens L1p1 included in the first lens group G1, the lens surface being on an image side, and

Lnr1: radius of curvature of a lens surface of the back-side negative lens L1nr included in the first lens group G1, the lens surface being on the object side.

Conditional Expression (4) defines the shape factor of an air lens between the first positive lens L1p1 and the back-side negative lens L1nr included in the first lens group G1. When Conditional Expression (4) is satisfied, the optical system OL having a wide angle of view and favorable optical performance can be obtained. When the lower limit value of Conditional Expression (4) is exceeded, it is difficult to correct spherical aberration and coma aberration, and thus such a value is not preferable. Meanwhile, it is possible to secure the advantageous effect of Conditional Expression (4) more surely by setting the lower limit value of Conditional Expression (4) to −7.500. Further, in order to secure the advantageous effect of Conditional Expression (4) more surely, it is preferable to set the lower limit value of Conditional Expression (4) to −5.000, −3.000, −2.000, −1.750, −1.500, −1.250, −1.150, −1.000, and more preferable to −0.950. Moreover, when the upper limit value of Conditional Expression (4) is exceeded, it is difficult to correct spherical aberration and coma aberration, and thus such a value is not preferable. Meanwhile, it is possible to secure the advantageous effect of Conditional Expression (4) more surely by setting, the upper limit value of Conditional Expression (4) to −0.100. Further, in order to secure the advantageous effect of Conditional Expression (4) more surely, it is preferable to set the upper limit value of Conditional Expression (4) to −0.250, −0.400, −0.417, −0.500, and more preferable to −0.550.

The optical system OL according to the present embodiment desirably satisfies Conditional Expression (5) shown below.

0.200<(−f1)/f2<4.500 (5)

in the expression,

f1: focal length of the first lens group G1, and

f2: focal length of the second lens group G2.

Conditional Expression (5) defines the ratio of the focal length of the first lens group G1 relative to the focal length of the second lens group G2. When Conditional Expression (5) is satisfied, it is possible to achieve favorable optical performance of the optical system OL and appropriately define the refractive power (power) of the first lens group G1 and the refractive power (power) of the second lens group G2. When the lower limit value of Conditional Expression (5) is exceeded, the refractive power (power) of the first lens group G1 is strong as compared to that of the second lens group G2, and it is difficult to correct coma aberration, field curvature, and astigmatism, and thus such a value is not preferable. Meanwhile, it is possible to secure the advantageous effect of Conditional Expression (5) more surely by setting the lower limit value of Conditional Expression (5) to 0.250. Further, in order to secure the advantageous effect of Conditional Expression (5), it is preferable to set the lower limit value of Conditional Expression (5) to 0.275, 0.300, 0.320, 0.340, 0.350, 0.370, 0.385, 0.400, 0.425, 0.450, 0.475, 0.500, 0.520, 0.535, and more preferable to 0.550. Moreover, when the upper limit value of Conditional Expression (5) is exceeded, the refractive power (power) of the first lens group G1 is weak as compared to that of the second lens group G2 and the diameter of the first lens group G1 increases, and thus such a value is not preferable. Furthermore, when the refractive power (power) of the second lens group G2 is strong, spherical aberration degrades, and thus such a value is not preferable. Meanwhile, it is possible to secure the advantageous effect of Conditional Expression (5) more surely by setting the upper limit value of Conditional Expression (5) to 4.250. Further, in order to secure the advantageous effect of Conditional Expression (5) more surely, it is preferable to set the upper limit value of Conditional Expression (5) to 4.000, 3.750, 3.500, 3.400, 3.300, 3.200, 3.100, 3.025, 2.800, 2.500, 2.250, 2.000, 1.800, and more preferable to 1.600.

The optical system OL according to the present embodiment desirably satisfies Conditional Expression (6) shown below.

0.130<Dn/f<3.500 (6)

in the expression,

Dn: thickness of a negative lens on the optical axis, the negative lens being disposed closest to the image side among the negative lenses included in the first lens group G1, and

f: overall focal length of the optical system OL.

Conditional Expression (6) defines the ratio of the thickness of the negative lens (L1nr) on the optical axis relative to the overall focal length of the optical system OL, the negative lens (L1nr) being disposed closest to the image side among the negative lenses included in the first lens group G1. When Conditional Expression (6) is satisfied, it is possible to achieve the wide angle of view and size reduction and obtain the optical system OL having favorable optical performance. When the lower limit value of Conditional Expression (6) is exceeded, the total length of the optical system OL is large, and thus such a value is not preferable. Furthermore, it is difficult to correct coma aberration, and thus such a value is not preferable. Meanwhile, it is possible to secure the advantageous effect of Conditional Expression (6) more surely by setting the lower limit value of Conditional Expression (6) to 0.150. Further, in order to secure the advantageous effect of Conditional Expression (6), it is preferable to set the lower limit value of Conditional Expression (6) to 0.180, 0.200, 0.210, 0.220, and more preferable to 0.230. Moreover, when the upper limit value of Conditional Expression (6) is exceeded, it is difficult to correct coma aberration, and thus such a value is not preferable. Meanwhile, it is possible to secure the advantageous effect of Conditional Expression (6) more surely by setting the upper limit value of Conditional Expression (6) to 3.450. Further, in order to secure the advantageous effect of Conditional Expression (6) more surely, it is preferable to set the upper limit value of Conditional Expression (6) to 3.400, 3.350, 3.300, 3.250, 3.200, 3.150, and more preferable to 3.120.

The optical system OL according to the present embodiment desirably satisfies Conditional Expression (7) shown below.

0.020<Dn/(−f1)<1.500 (7)

in the expression,

Dn: thickness of a negative lens on the optical axis, the negative lens being disposed closest to the image side among the negative lenses included in the first lens group G1, and

f1: focal length of the first lens group G1.

Conditional Expression (7) defines the ratio of the thickness of the negative lens (L1nr) on the optical axis relative to the focal length of the first lens group G1, the negative lens (L1nr) being disposed closest to the image side among the negative lenses included in the first lens group G1. When Conditional Expression (7) is satisfied, it is possible to achieve the wide angle of view and size reduction and obtain the optical system OL having favorable optical performance. When the lower limit value of Conditional Expression (7) is exceeded, it is difficult to ensure back focus of the optical system OL, and thus such a value is not preferable. Furthermore, it is difficult to correct field curvature and astigmatism, and thus such a value is not preferable. Meanwhile, it is possible to secure the advantageous effect of Conditional Expression (7) more surely by setting the lower limit value of Conditional Expression (7) to 0.030. Further, in order to secure the advantageous effect of Conditional Expression (7), it is preferable to set the lower limit value of Conditional Expression (7) to 0.040, 0.045, 0.050, 0.055, 0.060, 0.065, and more preferable to 0.068. Moreover, when the upper limit value of Conditional Expression (7) is exceeded, it is difficult to correct coma aberration, and thus such a value is not preferable. Meanwhile, it is possible to secure the advantageous effect of Conditional Expression (7) more surely by setting the upper limit value of Conditional Expression (7) to 1.400. Further, in order to secure the advantageous effect of Conditional Expression (7) more surely, it is preferable to set the upper limit value of Conditional Expression (7) to 1.350, 1.300, 1.250, 1.200, 1.150, 1.100, 1.050, 1.000, and more preferable to 0.940.

The optical system OL according to the present embodiment desirably satisfies Conditional Expression (8) shown below.

1.000<(−f1)/f<7.000 (8)

in the expression,

f1: focal length of the first lens group G1, and

f: overall focal length of the optical system OL.

Conditional Expression (8) defines the ratio of the focal length of the first lens group G1 relative to the overall focal length of the optical system OL. When Conditional Expression (8) is satisfied, it is possible to achieve the wide angle of view and size reduction and obtain the optical system OL having favorable optical performance. When the lower limit value of Conditional Expression (8) is exceeded, it is difficult to correct spherical aberration and coma aberration, and thus such a value is not preferable. Meanwhile, it is possible to secure the advantageous effect of Conditional Expression (8) more surely by setting the lower limit value of Conditional Expression (8) to 1.100. Further, in order to secure the advantageous effect of Conditional Expression (8), it is preferable to set the lower limit value of Conditional Expression (8) to 1.200, 1.300, 1.400, 1.500, 1.550, 1.600, 1.650, 1.700, 1.750, 1.800, and more preferable to 1.850. Moreover, when the upper limit value of Conditional Expression (8) is exceeded, the diameter of the first lens group G1 increases, and thus such a value is not preferable. Furthermore, it is difficult to correct field curvature and astigmatism, and thus such a value is not preferable. Meanwhile, it is possible to secure the advantageous effect of Conditional Expression (8) more surely by setting the upper limit value of Conditional Expression (8) to 6.800. Further, in order to secure the advantageous effect of Conditional Expression (8) more surely, it is preferable to set the upper limit value of Conditional Expression (8) to 6.500, 6.300, 6.150, 6.000, 5.850, 5.600, 5.500, 5.400, 5.300, 5.250, and more preferable to 5.200.

The optical system OL according to the present embodiment desirably satisfies Conditional Expression (9) shown below.

2.500<f2/f<4.500 (9)

in the expression,

f2: focal length of the second lens group G2, and

f: overall focal length of the optical system OL.

Conditional Expression (9) defines the ratio of the focal length of the second lens group G2 relative to the overall focal length of the optical system OL. When Conditional Expression (9) is satisfied, it is possible to achieve the wide angle of view and size reduction and obtain the optical system OL having favorable optical performance. When the lower limit value of Conditional Expression (9) is exceeded, it is difficult to correct field curvature, coma aberration, and lateral chromatic aberration, and thus such a value is not preferable. Meanwhile, it is possible to secure the advantageous effect of Conditional Expression (9) more surely by setting the lower limit value of Conditional Expression (9) to 2.550. Further, in order to secure the advantageous effect of Conditional Expression (9), it is preferable to set the lower limit value of Conditional Expression (9) to 2.600, 2.650, 2.680, and more preferable to 2.700. Moreover, when the upper limit value of Conditional Expression (9) is exceeded, the refractive power (power) of the second lens group G2 is weak and the total length of the optical system OL is large, and thus such a value is not preferable. Furthermore, it is difficult to correct spherical aberration and coma aberration, and thus such a value is not preferable. Meanwhile, it is possible to secure the advantageous effect of Conditional Expression (9) more surely by setting the upper limit value of Conditional Expression (9) to 4.300. Further, in order to secure the advantageous effect of Conditional Expression (9) more surely, it is preferable to set the upper limit value of Conditional Expression (9) to 4.150, 4.000, 3.980, 3.950, 3.930, 3.900, and more preferable to 3.890.

The optical system OL according to the present embodiment desirably satisfies Conditional Expression (10) shown below.

0.100<D12/(−f11)<0.500 (10)

in the expression,

D12: distance on the optical axis between the two negative lenses disposed closest to the object side in the first lens group G1, and

f11: focal length of a negative lens disposed closest to the object side in the first lens group G1.

Conditional Expression (10) defines the ratio of the distance on the optical axis between the two negative lenses (L1n1 and L1n2) disposed closest to the object side in the first lens group G1 relative to the focal length of the negative lens (L1n1) disposed closest to the object side in the first lens group G1. When Conditional Expression (10) is satisfied, it is possible to achieve the wide angle of view and size reduction and obtain the optical system OL having favorable optical performance. When the lower limit value of Conditional Expression (10) is exceeded, the total length of the optical system OL is large, and thus such a value is not preferable. Furthermore, it is difficult to correct spherical aberration and coma aberration, and thus such a value is not preferable. Meanwhile, it is possible to secure the advantageous effect of Conditional Expression (10) more surely by setting the lower limit value of Conditional Expression (10) to 0.110. Further, in order to secure the advantageous effect of Conditional Expression (10), it is preferable to set the lower limit value of Conditional Expression (10) to 0.125, 0.140, 0.145, 0.150, 0.155, and more preferable to 0.160. Moreover, when the upper limit value of Conditional Expression (10) is exceeded, the total length of the optical system OL is large, and thus such a value is not preferable. Furthermore, it is difficult to correct field curvature, coma aberration, and lateral chromatic aberration, and thus such a value is not preferable. Meanwhile, it is possible to secure the advantageous effect of Conditional Expression (10) more surely by setting the upper limit value of Conditional Expression (10) to 0.490. Further, in order to secure the advantageous effect of Conditional Expression (10) more surely, it is preferable to set the upper limit value of Conditional Expression (10) to 0.475, 0.450, 0.425, 0.410, 0.400, 0.390, 0.380, 0.375, and more preferable to 0.370.

The optical system OL according to the present embodiment desirably satisfies Conditional Expression (11) shown below.

0.015<DS/(−f1)<1.500 (11)

in the expression,

DS: distance on the optical axis from a lens surface closest to the image side in the first lens group G1 to a lens surface closest to the object side in the second lens group G2, and

f1: focal length of the first lens group G1.

Conditional Expression (11) defines the ratio of the distance on the optical axis from the lens surface closest to the image side in the first lens group G1 to the lens surface closest to the object side in the second lens group G2 relative to the focal length of the first lens group G1. When Conditional Expression (11) is satisfied, it is possible to achieve the wide angle of view and size reduction and obtain the optical system OL having favorable optical performance. When the lower limit value of Conditional Expression (11) is exceeded, the total length of the optical system OL is large, and thus such a value is not preferable. Furthermore, it is difficult to correct spherical aberration and coma aberration, and thus such a value is not preferable. Meanwhile, it is possible to secure the advantageous effect of Conditional Expression (11) more surely by setting the lower limit value of Conditional Expression (11) to 0.018. Further, in order to secure the advantageous effect of Conditional Expression (11), it is preferable to set the lower limit value of Conditional Expression (11) to 0.020, 0.022, and more preferable to 0.024. Moreover, when the upper limit value of Conditional Expression (11) is exceeded, the total length of the optical system OL is large, and thus such a value is not preferable. Furthermore, it is difficult to correct spherical aberration and coma aberration, and thus such a value is not preferable. Meanwhile, it is possible to secure the advantageous effect of Conditional Expression (11) more surely by setting the upper limit value of Conditional Expression (11) to 1.450. Further, in order to secure the advantageous effect of Conditional Expression (11) more surely, it is preferable to set the upper limit value of Conditional Expression (11) to 1.400, 1.350, 1.300, 1.250, 1.200, 1.185, 1.170, 1.150, and more preferable to 1.125.

The optical system OL according to the present embodiment desirably satisfies Conditional Expression (12) shown below.

0.005<DS/(−f11)<0.250 (12)

in the expression,

DS: distance on the optical axis from the lens surface closest to the image side in the first lens group G1 to the lens surface closest to the object side in the second lens group G2, and

f11: focal length of the negative lens disposed closest to the object side in the first lens group G1.

Conditional Expression (12) defines the ratio of the distance on the optical axis from the lens surface closest to the image side in the first lens group G1 to the lens surface closest to the object side in the second lens group G2 relative to the focal length of the negative lens (L1n1) disposed closest to the object side in the first lens group G1. When Conditional Expression (12) is satisfied, it is possible to achieve the wide angle of view and size reduction and obtain the optical system OL having favorable optical performance. When the lower limit value of Conditional Expression (12) is exceeded, the total length of the optical system OL is large, and thus such a value is not preferable. Furthermore, it is difficult to correct spherical aberration and coma aberration, and thus such a value is not preferable. Meanwhile, it is possible to secure the advantageous effect of Conditional Expression (12) more surely by setting the lower limit value of Conditional Expression (12) to 0.007. Further, in order to secure the advantageous effect of Conditional Expression (12), it is preferable to set the lower limit value of Conditional Expression (12) to 0.008, and more preferable to 0.009. Moreover, when the upper limit value of Conditional Expression (12) is exceeded, the total length of the optical system OL is large, and thus such a value is not preferable. Furthermore, it is difficult to correct spherical aberration and coma aberration, and thus such a value is not preferable. Meanwhile, it is possible to secure the advantageous effect of Conditional Expression (12) more surely by setting the upper limit value of Conditional Expression (12) to 0.235. Further, in order to secure the advantageous effect of Conditional Expression (12) more surely, it is preferable to set the upper limit value of Conditional Expression (12) to 0.220, 0.200, 0.180, 0.150, 0.125, 0.110, and more preferable to 0.100.

The optical system OL according to the present embodiment desirably satisfies Conditional Expression (13) shown below.

−1.000<(L1r2−L1r1)/(L1r2+L1r1)<−0.250 (13)

in the expression,

L1r1: radius of curvature of a lens surface of the negative lens disposed closest to the object side in the first lens group G1, the lens surface being on the object side, and

L1r2: radius of curvature of a lens surface of the negative lens disposed closest to the object side in the first lens group G1, the lens surface being on the image side.

Conditional Expression (13) defines the shape factor of the negative lens (L1n1) disposed closest to the object side in the first lens group G1. When Conditional Expression (13) is satisfied, the optical system OL having favorable optical performance can be obtained. When the lower limit value of Conditional Expression (13) is exceeded, it is difficult to correct field curvature and astigmatism, and thus such a value is not preferable. Meanwhile, it is possible to secure the advantageous effect of Conditional Expression (13) more surely by setting the lower limit value of Conditional Expression (13) to −0.900. Further, in order to secure the advantageous effect of Conditional Expression (13) more surely, it is preferable to set the lower limit value of Conditional Expression (13) to −0.750, −0.700, −0.676, −0.650, −0.625, −0.600, −0.575, −0.550, and more preferable to −0.525. Moreover, when the upper limit value of Conditional Expression (13) is exceeded, it is difficult to correct field curvature, astigmatism, and coma aberration, and thus such a value is not preferable. Meanwhile, it is possible to secure the advantageous effect of Conditional Expression (13) more surely by setting the upper limit value of Conditional Expression (13) to −0.270. Further, in order to secure the advantageous effect of Conditional Expression (13) more surely, it is preferable to set the upper limit value of Conditional Expression (13) to −0.282, −0.290, −0.300, −0.305, −0.310, −0.315, and more preferable to −0.320.

The optical system OL according to the present embodiment desirably satisfies Conditional Expression (14) shown below.

8.500<TL/f<21.000 (14)

in the expression,

TL: total length of the optical system OL, and

f: overall focal length of the optical system OL.

Conditional Expression (14) defines the ratio of the total length of the optical system OL relative to the overall focal length thereof. When Conditional Expression (14) is satisfied, it is possible to achieve the wide angle of view and size reduction and obtain the optical system OL having favorable optical performance. When the lower limit value of Conditional Expression (14) is exceeded, it is difficult to correct field curvature, astigmatism, and coma aberration, and thus such a value is not preferable. Meanwhile, it is possible to secure the advantageous effect of Conditional Expression (14) more surely by setting the lower limit value of Conditional Expression (14) to 8.750. Further, in order to secure the advantageous effect of Conditional Expression (14), it is preferable to set the lower limit value of Conditional Expression (14) to 9.000, 9.250, 9.500, 9.750, 9.950, 10.000, 10.250, 10.500, 10.750, 11.000, and more preferable to 11.250. Moreover, when the upper limit value of Conditional Expression (14) is exceeded, the total length of the optical system OL is large, and thus such a value is not preferable. Furthermore, it is difficult to correct field curvature, astigmatism, and coma aberration, and thus such a value is not preferable. Meanwhile, it is possible to secure the advantageous effect of Conditional Expression (14) more surely by setting the upper limit value of Conditional Expression (14) to 20.600. Further, in order to secure the advantageous effect of Conditional Expression (14) more surely, it is preferable to set the upper limit value of Conditional Expression (14) to 20.100, 20.000, 19.850, 19.700, 19.500, and more preferable to 19.250.

The optical system OL according to the present embodiment desirably satisfies Conditional Expression (15) shown below.

0.800<BF/f<2.800 (15)

in the expression,

BF: back focus of the optical system OL, and

f: overall focal length of the optical system OL.

Conditional Expression (15) defines the ratio of the back focus of the optical system OL relative to the overall focal length thereof. When Conditional Expression (15) is satisfied, it is possible to achieve the wide angle of view and size reduction and obtain the optical system OL having favorable optical performance. When the lower limit value of Conditional Expression (15) is exceeded, it is difficult to correct distortion, field curvature and astigmatism, and thus such a value is not preferable. Meanwhile, it is possible to secure the advantageous effect of Conditional Expression (15) more surely by setting the lower limit value of Conditional Expression (15) to 0.825. Further, in order to secure the advantageous effect of Conditional Expression (15), it is preferable to set the lower limit value of Conditional Expression (15) to 0.850, 0.875, and more preferable to 0.900. Moreover, when the upper limit value of Conditional Expression (15) is exceeded, the diameter of the first lens group G1 increases, and thus such a value is not preferable. Moreover, it is difficult to correct distortion, field curvature, and astigmatism, and thus such a value is not preferable. Meanwhile, it is possible to secure the advantageous effect of Conditional Expression (15) more surely by setting the upper limit value of Conditional Expression (15) to 2.700. Further, in order to secure the advantageous effect of Conditional Expression (15) more surely, it is preferable to set the upper limit value of Conditional Expression (15) to 2.600, 2.550, 2.500, 2.450, 2.400, and more preferable to 2.380.

The optical system OL according to the present embodiment desirably satisfies Conditional Expression (16) shown below.

5.000<ΣD1/f<13.000 (16)

in the expression,

ΣD1: distance on the optical axis from a lens surface closest to the object side to a lens surface closest to the image side in the first lens group G1, and

f: overall focal length of the optical system OL.

Conditional Expression (16) defines the ratio of the distance on the optical axis from the lens surface closest to the object side to the lens surface closest to the image side in the first lens group G1 relative to the overall focal length of the optical system OL. When Conditional Expression (16) is satisfied, it is possible to achieve the wide angle of view and size reduction and obtain the optical system OL having favorable optical performance. When the lower limit value of Conditional Expression (16) is exceeded, it is difficult to correct spherical aberration, coma aberration, and field curvature, and thus such a value is not preferable. Meanwhile, it is possible to secure the advantageous effect of Conditional Expression (16) more surely by setting the lower limit value of Conditional Expression (16) to 5.250. Further, in order to secure the advantageous effect of Conditional Expression (16), it is preferable to set the lower limit value of Conditional Expression (16) to 5.500, 5.800, 6.000, and more preferable to 6.100. Moreover, when the upper limit value of Conditional Expression (16) is exceeded, the total length of the optical system OL increases, and thus such a value is not preferable. Furthermore, it is difficult to correct distortion and field curvature, and thus such a value is not preferable. Meanwhile, it is possible to secure the advantageous effect of Conditional Expression (16) more surely by setting the upper limit value of Conditional Expression (16) to 12.500. Further, in order to secure the advantageous effect of Conditional Expression (16) more surely, it is preferable to set the upper limit value of Conditional Expression (16) to 12.000, 11.850, 11.800, 11.750, and more preferable to 11.700.

The optical system OL according to the present embodiment desirably satisfies Conditional Expression (17) shown below.

2.800<ΣD2/f<8.200 (17)

in the expression,

ΣD2: distance on the optical axis from the lens surface closest to the object side to the lens surface closest to the image side in the second lens group G2, and

f: overall focal length of the optical system OL.

Conditional Expression (17) defines the ratio of the distance on the optical axis from the lens surface closest to the object side to the lens surface closest to the image side in the second lens group G2 relative to the overall focal length of the optical system OL. When Conditional Expression (17) is satisfied, it is possible to achieve the wide angle of view and size reduction and obtain the optical system OL having favorable optical performance. When the lower limit value of Conditional Expression (17) is exceeded, it is difficult to correct field curvature and astigmatism, and thus such a value is not preferable. Meanwhile, it is possible to secure the advantageous effect of Conditional Expression (17) more surely by setting the lower limit value of Conditional Expression (17) to 3.000. Further, in order to secure the advantageous effect of Conditional Expression (17), it is preferable to set the lower limit value of Conditional Expression (17) to 3.150, 3.300, 3.450, 3.500, 3.650, 3.750, and more preferable to 3.800. Moreover, when the upper limit value of Conditional Expression (17) is exceeded, the total length of the optical system OL increases, and thus such a value is not preferable. Furthermore, it is difficult to correct spherical aberration, coma aberration, and field curvature, and thus such a value is not preferable. Meanwhile, it is possible to secure the advantageous effect of Conditional Expression (17) more surely by setting the upper limit value of Conditional Expression (17) to 8.000. Further, in order to secure the advantageous effect of Conditional Expression (17) more surely, it is preferable to set the upper limit value of Conditional Expression (17) to 7.750, 7.550, 7.400, 7.150, 7.000, 6.850, 6.700, 6.500, 6.350, 6.200, 6.100, and more preferable to 6.000.

The optical system OL according to the present embodiment desirably satisfies Conditional Expression (18) shown below.

1.000<(−f1ne)/f<3.000 (18)

in the expression,

f1ne: combined focal length of negative lenses disposed on the object side of the first positive lens in the first lens group G1, and

f: overall focal length of the optical system OL.

Conditional Expression (18) defines the ratio of the combined focal length of the negative lenses disposed on the object side of the first positive lens in the first lens group G1 relative to the overall focal length of the optical system OL. When Conditional Expression (18) is satisfied, it is possible to achieve the wide angle of view and size reduction and obtain the optical system OL having favorable optical performance. When the lower limit value of Conditional Expression (18) is exceeded, it is difficult to correct field curvature and astigmatism, and thus such a value is not preferable. Meanwhile, it is possible to secure the advantageous effect of Conditional Expression (18) more surely by setting the lower limit value of Conditional Expression (18) to 1.050. Further, in order to secure the advantageous effect of Conditional Expression (18), it is preferable to set the lower limit value of Conditional Expression (18) to 1.100, 1.115, 1.200, 1.225, 1.250, 1.275, 1.290, and more preferable to 1.300. Moreover, when the upper limit value of Conditional Expression (18) is exceeded, the diameter of the first lens group G1 increases, and thus such a value is not preferable. Furthermore, it is difficult to correct field curvature and astigmatism, and thus such a value is not preferable. Meanwhile, it is possible to secure the advantageous effect of Conditional Expression (18) more surely by setting the upper limit value of Conditional Expression (18) to 2.850. Further, in order to secure the advantageous effect of Conditional Expression (18) more surely, it is preferable to set the upper limit value of Conditional Expression (18) to 2.700, 2.600, 2.500, 2.350, 2.200, 2.150, 2.100, and more preferable to 2.080.

The optical system OL according to the present embodiment desirably satisfies Conditional Expression (19) shown below.

1.200<f22/f<4.100 (19)

in the expression,

f22: focal length of a positive lens of a cemented lens closest to the object side among cemented lenses included in the second lens group G2, and

f: overall focal length of the optical system OL.

Conditional Expression (19) defines the ratio of the focal length of the positive lens (L22) of the cemented lens (CL21) closest to the object side among the cemented lenses included in the second lens group G2 relative to the overall focal length of the optical system OL. When Conditional Expression (19) is satisfied, it is possible to achieve the wide angle of view and size reduction and obtain the optical system OL having favorable optical performance. When the lower limit value of Conditional Expression (19) is exceeded, it is difficult to correct field curvature, astigmatism, and coma aberration, and thus such a value is not preferable. Meanwhile, it is possible to secure the advantageous effect of Conditional Expression (19) more surely by setting the lower limit value of Conditional Expression (19) to 1.300. Further, in order to secure the advantageous effect of Conditional Expression (19), it is preferable to set the lower limit value of Conditional Expression (19) to 1.450, 1.550, 1.650, 1.700, 1.750, 1.800, 1.850, 1.900, and more preferable to 1.950. Moreover, when the upper limit value of Conditional Expression (19) is exceeded, it is difficult to correct field curvature, astigmatism, and coma aberration, and thus such a value is not preferable. Meanwhile, it is possible to secure the advantageous effect of Conditional Expression (19) more surely by setting the upper limit value of Conditional Expression (19) to 4.000. Further, in order to secure the advantageous effect of Conditional Expression (19) more surely, it is preferable to set the upper limit value of Conditional Expression (19) to 3.850, 3.700, 3.650, 3.500, 3.350, 3.200, 3.100, 3.000, and more preferable to 2.950.

The optical system OL according to the present embodiment desirably satisfies Conditional Expression (20) shown below.

−8.000<f2CL/(−f1)<90.000 (20)

in the expression,

f2CL: focal length of the cemented lens disposed closest to the object side among the cemented lenses included in the second lens group G2, and f: overall focal length of the optical system OL.

Conditional Expression (20) defines the ratio of the focal length of the cemented lens (CL21) disposed closest to the object side among the cemented lenses included in the second lens group G2 relative to the overall focal length of the optical system OL. When Conditional Expression (20) is satisfied, it is possible to achieve the wide angle of view and size reduction and obtain the optical system OL having favorable optical performance. When the lower limit value of Conditional Expression (20) is exceeded, the refractive power (power) of the cemented lens disposed closest to the object side among the cemented lenses included in the second lens group G2 is strong and it is difficult to correct spherical aberration and coma aberration, and thus such a value is not preferable. Meanwhile, it is possible to secure the advantageous effect of Conditional Expression (20) more surely by setting the lower limit value of Conditional Expression (20) to −7.500. Further, in order to secure the advantageous effect of Conditional Expression (20) more surely, it is preferable to set the lower limit value of Conditional Expression (20) to −7.000, −6.700, −6.500, −6.250, −6.000, −5.750, −5.550, and more preferable to −5.540. Moreover, when the upper limit value of Conditional Expression (20) is exceeded, the refractive power (power) of the first lens group G1 is strong and it is difficult to correct spherical aberration, coma aberration, and field curvature, and thus such a value is not preferable. Meanwhile, it is possible to secure the advantageous effect of Conditional Expression (20) more surely by setting the upper limit value of Conditional Expression (20) to 80.000. Further, in order to secure the advantageous effect of Conditional Expression (20) more surely, it is preferable to set the upper limit value of Conditional Expression (20) to 70.000, 64.500, 60.000, 55.000, 50.000, 45.000, and more preferable to 40.000.

The optical system OL according to the present embodiment desirably satisfies Conditional Expression (21) shown below.

0.500<(−f1ne)/θmax<4.500 (21)

in the expression,

f1ne: combined focal length of the negative lenses disposed on the object side of the first positive lens in the first lens group G1, and

θmax: maximum value [radian] of the half angle of view of the optical system OL.

Conditional Expression (21) defines the ratio of the combined focal length of the negative lenses disposed on the object side of the first positive lens in the first lens group G1 relative to the maximum value of the half angle of view of the optical system OL. When Conditional Expression (21) is satisfied, it is possible to achieve the wide angle of view and size reduction and obtain the optical system OL having favorable optical performance. When the lower limit value of Conditional Expression (21) is exceeded, the combined refractive power (power) of the negative lenses disposed on the object side of the first positive lens in the first lens group G1 is too strong for the angle of view of the optical system OL, which degrades field curvature, and thus such a value is not preferable. Furthermore, when the angle of view of the optical system OL decreases, the angle of view is not a wide angle of view that is desired for as an ultrawide-angle lens, and thus such a value is not preferable. Meanwhile, it is possible to secure the advantageous effect of Conditional Expression (21) more surely by setting the lower limit value of Conditional Expression (21) to 0.525. Further, in order to secure the advantageous effect of Conditional Expression (21), it is preferable to set the lower limit value of Conditional Expression (21) to 0.540, 0.550, 0.575, 0.590, 0.625, 0.800, 0.850, 0.900, 0.950, 0.975, and more preferable to 1.000. Moreover, when the upper limit value of Conditional Expression (21) is exceeded, the combined refractive power (power) of the negative lenses disposed on the object side of the first positive lens in the first lens group G1 is too weak for the angle of view of the optical system OL, which degrades field curvature, and thus such a value is not preferable. Meanwhile, it is possible to secure the advantageous effect of Conditional Expression (21) more surely by setting the upper limit value of Conditional Expression (21) to 4.000. Further, in order to secure the advantageous effect of Conditional Expression (21) more surely, it is preferable to set the upper limit value of Conditional Expression (21) to 3.750, 3.500, 3.200, 3.000, 2.750, 2.500, 2.250, 2.000, 1.850, and more preferable to 1.700.

The optical system OL according to the present embodiment desirably satisfies Conditional Expression (22) shown below.

32.000<νda<70.000 (22)

in the expression,

νda: average value of the Abbe numbers of the media of the negative lenses disposed on the object side of the first positive lens in the first lens group G1 at a d line.

Conditional Expression (22) defines the average value of the Abbe numbers of the media of the lenses disposed on the object side of the first positive lens in the first lens group G1 at the d line. When Conditional Expression (22) is satisfied, it is possible to achieve the wide angle of view and size reduction and obtain the optical system OL having favorable optical performance. When the lower limit value of Conditional Expression (22) is exceeded, it is difficult to correct color components of lateral chromatic aberration and coma aberration, and thus such a value is not preferable. Meanwhile, it is possible to secure the advantageous effect of Conditional Expression (22) more surely by setting the lower limit value of Conditional Expression (22) to 32.500. Further, in order to secure the advantageous effect of Conditional Expression (22), it is preferable to set the lower limit value of Conditional Expression (22) to 33.000, 33.500, and more preferable to 34.000. Moreover, when the upper limit value of Conditional Expression (22) is exceeded, it is difficult to correct color components of lateral chromatic aberration and coma aberration, and thus such a value is not preferable. Meanwhile, it is possible to secure the advantageous effect of Conditional Expression (22) more surely by setting the upper limit value of Conditional Expression (22) to 68.000. Further, in order to secure the advantageous effect of Conditional Expression (22), it is preferable to set the upper limit value of Conditional Expression (22) to 67.200.

The optical system OL according to the present embodiment desirably satisfies Conditional Expression (23) shown below.

0.250<(L3r1−L2r2)/(L3r1+L2r2)<1.500 (23)

in the expression,

L2r2: radius of curvature of a lens surface of a lens disposed second closest to the object side in the first lens group G1, the lens surface being on the image side, and

L3r1: radius of curvature of a lens surface of a lens disposed third closest to the object side in the first lens group G1, the lens surface being on the object side.

Conditional Expression (23) defines the shape factor of an air lens between the lens (L12) and the lens (L13) disposed second and third, respectively, closest to the object side in the first lens group G1. When Conditional Expression (23) is satisfied, the optical system OL having favorable optical performance can be obtained. When the lower limit value of Conditional Expression (23) is exceeded, it is difficult to correct field curvature and astigmatism, and thus such a value is not preferable. Meanwhile, it is possible to secure the advantageous effect of Conditional Expression (23) more surely by setting the lower limit value of Conditional Expression (23) to 0.280. Further, in order to secure the advantageous effect of Conditional Expression (23), it is preferable to set the lower limit value of Conditional Expression (23) to 0.300, 0.325, 0.340, and more preferable to 0.380. Moreover, when the upper limit value of Conditional Expression (23) is exceeded, it is difficult to correct field curvature, astigmatism, and coma aberration, and thus such a value is not preferable. Meanwhile, it is possible to secure the advantageous effect of Conditional Expression (23) more surely by setting the upper limit value of Conditional Expression (23) to 1.400. Further, in order to secure the advantageous effect of Conditional Expression (23) more surely, it is preferable to set the upper limit value of Conditional Expression (23) to 1.300, 1.250, 1.200, 1.175, 1.150, and more preferable to 1.120.

In the optical system OL according to the present embodiment, a lens closest to the object side in the second lens group G2 preferably has a lens surface formed in an aspheric shape on the object side and a lens surface formed in an aspheric shape on the image side. With such a configuration, it is possible to correct coma aberration, field curvature, astigmatism, and distortion.

The contents described below are employable as appropriate to the extent that the optical performance is not compromised.

In the present embodiment, the optical system OL having a two-group configuration has been shown, and the configuration conditions and others are also applicable to a three-group configuration, a four-group configuration, and other group configurations. Further, the optical system OL may instead have a configuration in which a lens or a lens group closest to the object side is added or a configuration in which a lens or a lens group closest to the image side is added. The lens group represents a portion including at least one lens separated from another by an air space that changes at magnification change or focusing.

A focusing group may be a single lens group, a plurality of lens groups, or a partial lens group moved in the optical axis direction to focus upon from an infinite distance object to a close distance object. In this case, the focusing group can also be used to perform autofocusing and is suitably driven with a motor for autofocusing (such as an ultrasonic wave motor). In particular, the focusing group is preferably the entire optical system OL.

An anti-vibration group may be a lens group or a partial lens group so moved as to have a displacement component in the direction perpendicular to the optical axis or rotated (swung) in an in-plane direction containing the optical axis to correct an image blur caused by a shake of a hand. In particular, it is preferable that the anti-vibration group is the entire second lens group G2 or part of the second lens group G2.

A lens surface may be so formed as to be a spherical surface, a flat surface, or an aspheric surface. In the case where a lens surface is a spherical or flat surface, the lens is readily processed, assembled, and adjusted, whereby degradation in the optical performance due to errors in the lens processing, assembly, and adjustment is preferably avoided. Further, even when an image plane is shifted, the amount of degradation in drawing performance is preferably small. In the case where the lens surface is an aspheric surface, the aspheric surface may be any of a ground aspheric surface, a glass molded aspheric surface that is a glass surface so molded in a die as to have an aspheric shape, and a composite aspheric surface that is a glass surface on which aspherically shaped resin is formed. The lens surface may instead be a diffractive surface, or the lenses may be any of a distributed index lens (GRIN lens) or a plastic lens.

The aperture stop S is preferably disposed between the first lens group G1 and the second lens group G2. Instead, no member as an aperture stop may be provided, and the frame of a lens may serve as the aperture stop.

Further, each lens surface may be provided with an antireflection film having high transmittance over a wide wavelength range to achieve good optical performance that reduces flare and ghost and achieves high contrast.

Note that configurations and conditions described above each achieve an above-described effect, and not all configurations and conditions necessarily need to be satisfied but the above-described effect can be obtained with either configuration or condition or with either combination of configurations or conditions.

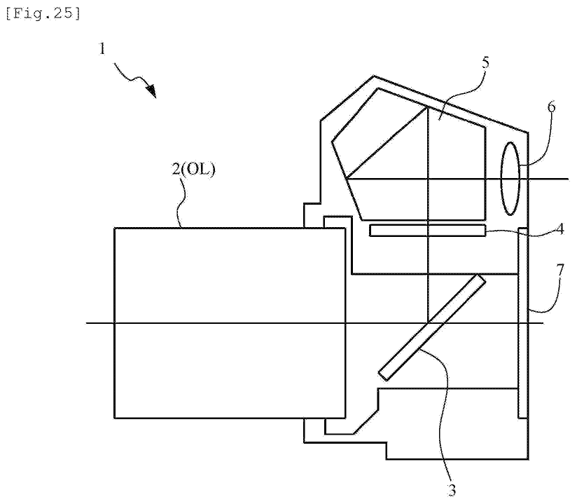

FIG. 25 shows a substantially cross-sectional view of a single-lens reflex camera 1 (hereinafter simply referred to as a camera) as an optical apparatus including the above-described optical system OL. In the camera 1, light from a non-shown object (subject) is condensed through an image pickup lens 2 (the optical system OL) and imaged on a focal point plate 4 through a quick return mirror 3. Then, the light imaged on the focal point plate 4 is reflected a plurality of times in a penta prism 5 and guided to an ocular lens 6. Accordingly, a photographer can observe an object (subject) image as an erected image through the ocular lens 6.

When a non-shown release button is pressed by the photographer, the quick return mirror 3 retracts out of the optical path and the light of the non-shown object (subject) condensed through the image pickup lens 2 forms a subject image on an image sensor 7. Accordingly, the light from the object (subject) is captured by the image sensor 7 and recorded as an object (subject) image in a non-shown memory. In this manner, the photographer can capture an image of an object (subject) with the camera 1. Note that the camera 1 shown in FIG. 25 may detachably hold the image pickup lens 2 or may be integrally formed with the image pickup lens 2. The camera 1 may be what is called a single-lens reflex camera or may be a compact camera or a mirror-less single-lens reflex camera that do not include a quick return mirror or the like.

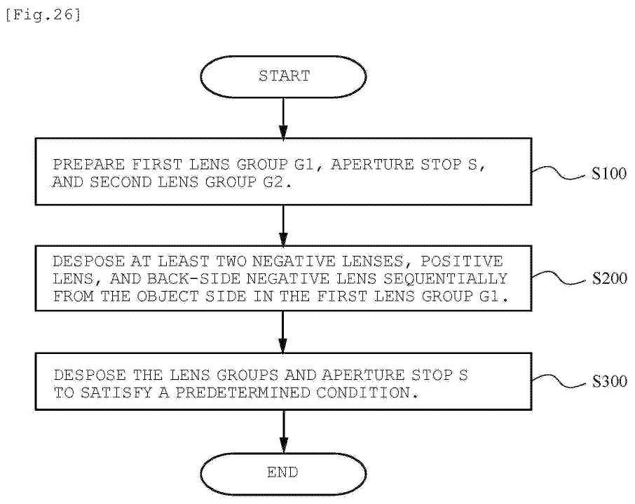

A method for manufacturing the optical system OL according to the present embodiment will be schematically described below with reference to FIG. 26. First, lenses are disposed to prepare the first lens group G1, the aperture stop S, and the second lens group G2 of the optical system OL (step S100). In addition, at least two negative lenses, a positive lens, and a back-side negative lens are disposed sequentially from the object side in the first lens group G1 (step S200). Then, the lens groups and the aperture stop S are disposed to satisfy a condition expressed by a predetermined conditional expression (for example, Conditional Expression (1) described above) (step S300).

Specifically, in the present embodiment, lenses of the optical system OL are disposed as shown in, for example, FIG. 1. Specifically, the negative meniscus lens L1n1 having a convex surface facing the object side, the aspheric negative lens L1n2 having a negative meniscus shape with a convex surface facing the object side and having a lens surface in an aspheric shape on the object side and a lens surface in an aspheric shape on the image side, the biconvex positive lens L1p1, and the negative meniscus lens L1nr having a concave surface facing the object side are disposed sequentially from the object side as the first lens group G1. In addition, a positive meniscus lens L21 having a convex surface facing the object side, the cemented positive lens CL21 formed by cementing the biconvex positive lens L22 and a biconcave negative lens L23, and an aspheric positive lens L24 having a biconvex shape and having a lens surface in an aspheric shape on the object side and a lens surface in an aspheric shape on the image side are disposed sequentially from the object side as the second lens group G2. Then, the lens groups and the aperture stop S thus prepared are disposed through the above-described procedure to manufacture the optical system OL.

With the above-described configurations, it is possible to provide a small-sized optical system having a wide angle of view and favorable optical performance, an optical apparatus including the optical system, and a method for manufacturing the optical system.

### EXAMPLES

Examples of the present application will be described below with reference to the drawings. Note that FIGS. 1, 3, 5, 7, 9, 11, 13, 15, 17, 19, 21, and 23 are cross-sectional views showing the configurations of optical systems OL (OL1 to OL12) according to the examples and the refractive power distribution thereof.

In the examples, each aspheric surface is expressed by Expression (a) below, where y represents the height in a direction orthogonal to the optical axis, S(y) represents the distance (sag amount) on the optical axis from a tangent plane at the apex of the aspheric surface at the height y to the aspheric surface, r represents the radius of curvature (paraxial radius of curvature) of a reference spherical surface, K represents the conic constant, and An represents the n-th aspheric surface coefficient. Note that, in the examples below, “E−n” represents “×10⁻ⁿ”.

S(y)=(y²/r)/{1+(1−K×y²/r²)^{1/2}}+A4×y⁴+A6×y⁶+A8×y⁸+A10×y¹⁰ (a)

Note that, in the examples, the second aspheric surface coefficient A2 is zero. In tables of the examples, “*” is provided on the right side of the surface number of an aspheric surface.

### First Example

FIG. 1 is a diagram showing the configuration of an optical system OL1 according to a first example. The optical system OL1 includes, sequentially from the object side, a first lens group G1 having negative refractive power, an aperture stop S, and a second lens group G2 having positive refractive power.

The first lens group G1 includes, sequentially from the object side, a negative meniscus lens L1n1 having a convex surface facing the object side, an aspheric negative lens L1n2 having a negative meniscus shape with a convex surface facing the object side and having a lens surface in an aspheric shape on the object side and a lens surface in an aspheric shape on the image side, a biconvex positive lens L1p1, and a negative meniscus lens L1nr having a concave surface facing the object side.

The second lens group G2 includes, sequentially from the object side, a positive meniscus lens L21 having a convex surface facing the object side, a cemented positive lens CL21 formed by cementing a biconvex positive lens L22 and a biconcave negative lens L23, and an aspheric positive lens L24 having a biconvex shape and having a lens surface in an aspheric shape on the object side and a lens surface in an aspheric shape on the image side.

In addition, in the optical system OL1, a filter group FL is disposed between the second lens group G2 and an image plane I.

Table 1 below shows values of specifications of the optical system OL1. In Table 1, the following specifications shown as overall specifications are defined as follows: f represents the overall focal length; FNO represents the F number; 2ω represents the angle of view [°]; Y represents the maximum image height; BF represents the back focus subjected to air conversion; and TL represents the value of the total length subjected to air conversion. The back focus BF represents the distance on the optical axis from the lens surface closest to the image side (sixteenth surface in the first example) to the image plane I. The total length TL represents the distance on the optical axis from a lens surface (first surface in the first example) closest to the object side to the image plane I. In the lens data, a first field m shows the sequence of lens surfaces (surface numbers) counted from the object side in a direction in which the rays travel. A second field r shows the radius of curvature of each lens surface. A third field d shows the distance (inter-surface distance) on the optical axis from each optical surface to the following optical surface. A fourth field nd and a fifth field νd show the refractive index and the Abbe number at the d line (λ=587.6 nm). A radius of curvature of 0.00000 represents a flat surface, and the refractive index of air, which is 1.00000, is omitted. The lens group focal length shows the number of the first surface and the focal length of each of the first lens group G1 and the second lens group G2.

The unit of each of the focal length f, the radius of curvature r, the inter-surface distance d, and other lengths shown in all the variety of specifications below is typically “mm”, but not limited to this, because an optical system provides the same optical performance even when the optical system is proportionally enlarged or reduced. Further, the description of the reference characters and the description of the specification tables hold true for those in the following examples.

TABLE 1
First example
[Overall specifications]

| | |
|---|---|
| f = | 1.5178 |
| FNO = | 2.8586 |
| 2ω = | 220.000° |
| Y = | 2.8200 |
| BF(air-conversion | 2.0694 |
| length) = | |
| TL(air-conversion | 25.1694 |
| length) = | |

[Lens data]

| m | r | d | nd | vd | |
|---|---|---|---|---|---|
| Object | ∞ | | | | |
| plane | | | | | |
| 1 | 20.3154 | 0.8000 | 1.755000 | 52.34 | |
| 2 | 6.9755 | 4.1500 | | | |
| 3* | 8.7447 | 1.0000 | 1.693500 | 53.18 | |
| 4* | 1.9381 | 2.3500 | | | |
| 5 | 9.4244 | 1.7000 | 1.846660 | 23.80 | |
| 6 | −24.8991 | 0.7000 | | | |
| 7 | −4.4304 | 3.5500 | 1.744000 | 44.81 | |
| 8 | −7.5000 | 0.4000 | | | |
| 9 | 0.0000 | 0.1000 | | | Aperture |
| | | | | | stop S |
| 10 | 4.9809 | 1.6000 | 1.497310 | 82.51 | |
| 11 | −30.3415 | 0.1000 | | | |
| 12 | 7.3595 | 3.4500 | 1.593190 | 67.90 | |
| 13 | −3.1500 | 0.5000 | 1.846660 | 23.80 | |
| 14 | 76.1573 | 0.2000 | | | |
| 15* | 5.2575 | 2.5000 | 1.693500 | 53.18 | |
| 16* | −16.6138 | 1.3443 | | | |
| 17 | 0.0000 | 0.5000 | 1.516800 | 64.14 | |
| 18 | 0.0000 | 0.3954 | | | |
| Image | ∞ | | | | |
| plane | | | | | |

[Focal length of lens groups]

| Lens group | First surface | Focal length |
|---|---|---|
| First lens group G1 | 1 | −5.1458 |
| Second lens group G2 | 12 | 4.9638 |

| | |
|---|---|
| θmax = | 1.920 |
| f11 = | −14.443 |
| f1ne = | −2.401 |
| f22 = | 4.236 |
| f2CL = | 198.183 |

In the optical system OL1, the third surface, the fourth surface, the fifteenth surface, and the sixteenth surface are formed in aspheric shapes. Table 2 below shows aspheric surface data, in other words, the values of the conic constant K and the aspheric surface constants A4 to A10.

TABLE 2
[Aspheric surface data]

| Surface | K | A4 | A6 | A8 | A10 |
|---|---|---|---|---|---|
| 3 | 1.0000 | −2.52352E−03 | 5.98991E−05 | −1.05680E−06 | 1.06305E−08 |
| 4 | −0.1019 | 1.46212E−03 | −3.99006E−04 | 2.90073E−05 | −6.00381E−07 |
| 15 | 1.0000 | −1.90663E−03 | 1.47871E−04 | −1.02048E−04 | 5.49155.E−06 |
| 16 | 1.0000 | 7.35654E−03 | 2.11884E−04 | −2.34313E−04 | 1.41715.E−05 |

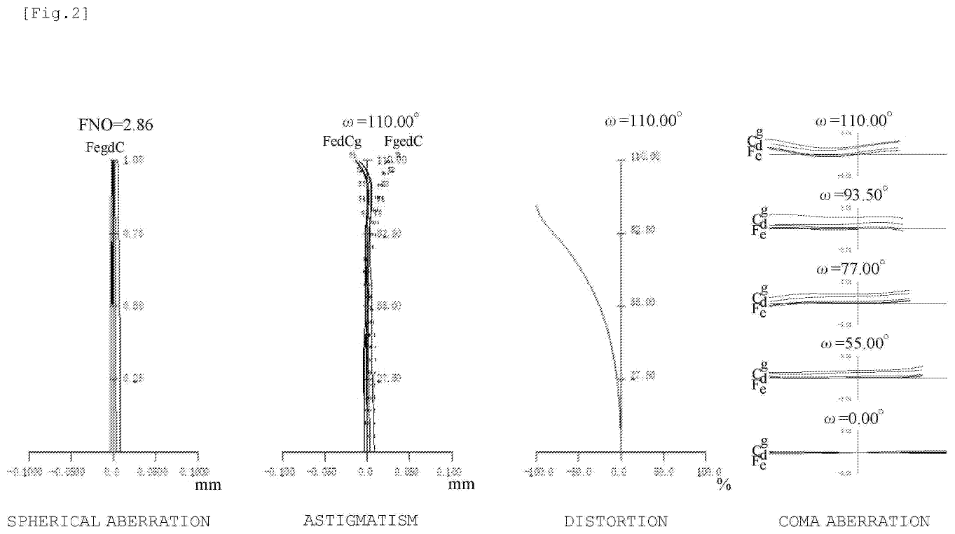

FIG. 2 shows a spherical aberration diagram, an astigmatism diagram, a distortion diagram, and a coma aberration diagram of the optical system OL1. In each aberration diagram, ω represents the half angle of view [°]. The spherical aberration diagram shows the value of the F number corresponding to the maximum aperture, the astigmatism diagram and the distortion diagram each show the maximum value of the half angle of view, and the coma aberration diagram shows the value of each half angle of view. Reference character d represents the d-line (λ=587.6 nm), reference character g represents the g-line (λ=435.8 nm), reference character e represents the e-line (λ=546.1 nm), reference character F represents the F-line (λ=486.1 nm), and reference character C represents the C-line (λ=656.3 nm). In the astigmatism diagram, the solid line represents the sagittal image plane, and the dashed line represents the meridional image plane. Further, in the aberration diagrams in the following examples, the same reference characters as those in the present example are used. The aberration diagrams show that the optical system OL1 allows favorable correction of the variety of aberrations.

### Second Example

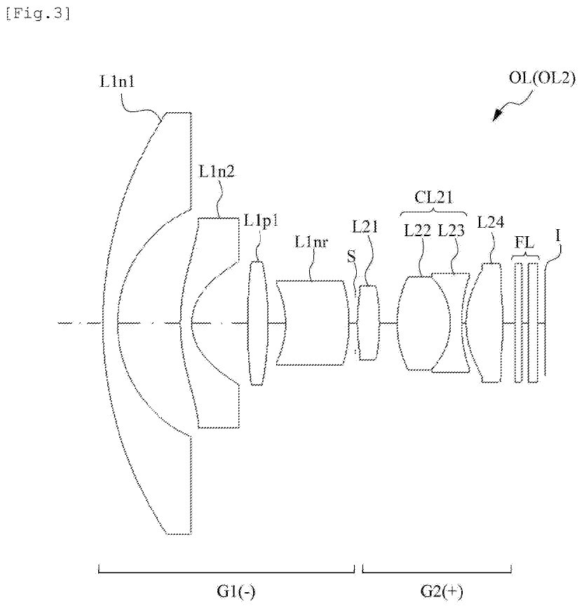

FIG. 3 is a diagram showing the configuration of an optical system OL2 according to a second example. The optical system OL2 includes, sequentially from the object side, a first lens group G1 having negative refractive power, an aperture stop S, and a second lens group G2 having positive refractive power.

The first lens group G1 includes, sequentially from the object side, a negative meniscus lens L1n1 having a convex surface facing the object side, an aspheric negative lens L1n2 having a negative meniscus shape with a convex surface facing the object side and having a lens surface in an aspheric shape on the object side and a lens surface in an aspheric shape on the image side, a biconvex positive lens L1p1, and a negative meniscus lens L1nr having a concave surface facing the object side.

The second lens group G2 includes, sequentially from the object side, an aspheric positive lens L21 having a biconvex shape and having a lens surface in an aspheric shape on the object side and a lens surface in an aspheric shape on the image side, a cemented negative lens CL21 formed by cementing a biconvex positive lens L22 and a biconcave negative lens L23, and an aspheric positive lens L24 having a biconvex shape and having a lens surface in an aspheric shape on the object side and a lens surface in an aspheric shape on the image side.

In addition, in the optical system OL2, a filter group FL is disposed between the second lens group G2 and an image plane I.

Table 3 below shows values of specifications of the optical system OL2.

TABLE 3
Second example
[Overall specifications]

| | |
|---|---|
| f = | 1.4487 |
| FNO = | 2.0559 |
| 2ω = | 220.000° |
| Y = | 2.8200 |
| BF(air-conversion | 1.9670 |
| length) = | |
| TL(air-conversion | 23.5170 |
| length) = | |

[Lens data]

| m | r | d | nd | vd | |
|---|---|---|---|---|---|
| Object | ∞ | 0.8000 | 1.755000 | 52.34 | |
| plane | 19.1086 | | | | |
| 1 | | | | | |
| 2 | 6.3759 | 3.4000 | | | |
| 3* | 9.9417 | 0.6000 | 1.693500 | 53.22 | |
| 4* | 2.3946 | 3.0000 | | | |
| 5 | 26.9545 | 1.1000 | 1.846660 | 23.80 | |
| 6 | −16.2094 | 0.9500 | | | |
| 7 | −4.4661 | 3.4000 | 1.744000 | 44.81 | |
| 8 | −7.5000 | 0.3500 | | | |
| 9 | 0.0000 | 0.1000 | | | Aperture |
| | | | | | stop S |
| 10* | 9.8889 | 1.2000 | 1.693500 | 53.22 | |
| 11* | −11.2853 | 0.9500 | | | |
| 12 | 5.2719 | 2.8500 | 1.593190 | 67.90 | |
| 13 | −3.3663 | 0.6000 | 1.846660 | 23.80 | |
| 14 | 7.1049 | 0.2500 | | | |
| 15* | 4.3144 | 2.0000 | 1.693500 | 53.22 | |
| 16* | −9.3117 | 0.6566 | | | |
| 17 | 0.0000 | 0.3500 | 1.516800 | 63.88 | |
| 18 | 0.0000 | 0.3500 | | | |
| Image | ∞ | | | | |
| plane | | | | | |

[Focal length of lens groups]

| Lens group | First surface | Focal length |
|---|---|---|
| First lens group G1 | 1 | −4.7278 |
| Second lens group G2 | 12 | 4.8507 |

| | |
|---|---|
| θmax = | 1.920 |
| f11 = | −13.026 |
| f1ne = | −2.865 |
| f22 = | 3.948 |
| f2CL= | −24.527 |

In the optical system OL2, the third surface, the fourth surface, the tenth surface, the eleventh surface, the fifteenth surface, and the sixteenth surface are formed in aspheric shapes. Table 4 below shows aspheric surface data, in other words, the values of the conic constant K and the aspheric surface constants A4 to A10.

TABLE 4
[Aspheric surface data]

| Surface | K | A4 | A6 | A8 | A10 |
|---|---|---|---|---|---|
| 3 | 1.0000 | 4.60642E−04 | −9.16400E−05 | 2.44500E−06 | −2.18788E−08 |
| 4 | 0.2931 | 1.83538E−03 | 1.35211E−04 | −3.20301E−05 | 9.97682E−08 |
| 10 | 1.0000 | −1.53632E−03 | −2.37975E−04 | −9.17618E−05 | 4.09373E−06 |
| 11 | 1.0000 | −1.48636E−03 | −7.05702E−04 | 1.09021E−04 | −2.53413E−05 |
| 15 | 1.0000 | −2.04709E−03 | 5.50454E−05 | −9.09945E−07 | −1.53251E−06 |
| 16 | 1.0000 | 6.98562E−03 | 2.46172E−04 | −7.83781E−05 | 1.90963E−06 |

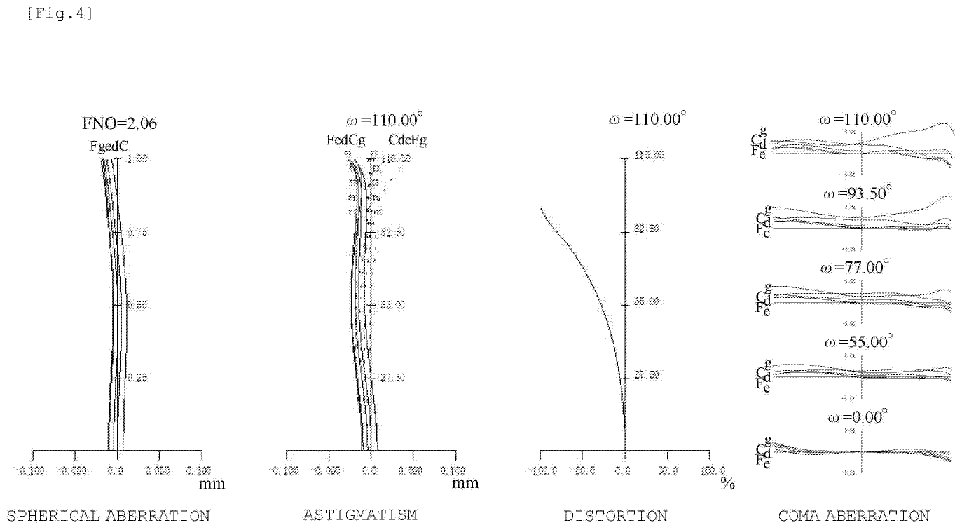

FIG. 4 shows a spherical aberration diagram, an astigmatism diagram, a distortion diagram, and a coma aberration diagram of the optical system OL2. The aberration diagrams show that the optical system OL2 allows favorable correction of the variety of aberrations.

### Third Example

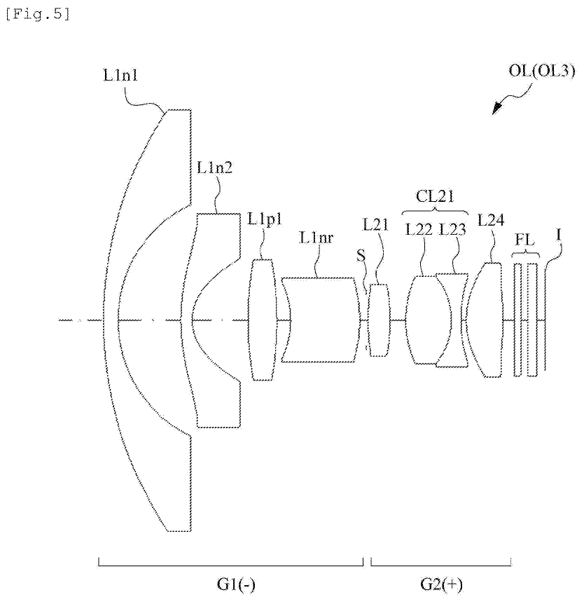

FIG. 5 is a diagram showing the configuration of an optical system OL3 according to a third example. The optical system OL3 includes, sequentially from the object side, a first lens group G1 having negative refractive power, an aperture stop S, and a second lens group G2 having positive refractive power.

The first lens group G1 includes, sequentially from the object side, a negative meniscus lens L1n1 having a convex surface facing the object side, an aspheric negative lens L1n2 having a negative meniscus shape with a convex surface facing the object side and having a lens surface in an aspheric shape on the object side and a lens surface in an aspheric shape on the image side, a biconvex positive lens L1p1, and a negative meniscus lens L1nr having a concave surface facing the object side.

The second lens group G2 includes, sequentially from the object side, an aspheric positive lens L21 having a biconvex shape and having a lens surface in an aspheric shape on the object side and a lens surface in an aspheric shape on the image side, a cemented negative lens CL21 formed by cementing a biconvex positive lens L22 and a biconcave negative lens L23, and an aspheric positive lens L24 having a biconvex shape and having a lens surface in an aspheric shape on the object side and a lens surface in an aspheric shape on the image side.

In addition, in the optical system OL3, a filter group FL is disposed between the second lens group G2 and an image plane I.

Table 5 below shows values of specifications of the optical system OL3.

TABLE 5
Third example
[Overall specifications]

| | |
|---|---|
| f = | 1.3638 |
| FNO = | 2.0533 |
| 2ω = | 220.000° |
| Y= | 2.8200 |
| BF(air-conversion | 1.9370 |
| length) = | |
| TL(air-conversion | 23.4870 |
| length) = | |

[Lens data]

| m | r | d | nd | vd | |
|---|---|---|---|---|---|
| Object | ∞ | | | | |
| plane | | | | | |
| 1 | 18.9628 | 0.8000 | 1.755000 | 52.33 | |
| 2 | 6.5583 | 3.4000 | | | |
| 3* | 10.9030 | 0.6000 | 1.693500 | 53.20 | |
| 4* | 2.3414 | 3.0000 | | | |
| 5 | 17.4777 | 1.5500 | 1.846660 | 23.80 | |
| 6 | −17.4777 | 0.7500 | | | |
| 7 | −4.4656 | 3.7000 | 1.744000 | 44.80 | |
| 8 | −7.5000 | 0.3500 | | | |
| 9 | 0.0000 | 0.1000 | | | Aperture |
| | | | | | stop S |
| 10* | 8.7948 | 1.2000 | 1.693500 | 53.20 | |
| 11* | −12.3818 | 0.8500 | | | |
| 12 | 5.2898 | 2.4500 | 1.593190 | 67.90 | |
| 13 | −3.4948 | 0.5000 | 1.846660 | 23.80 | |
| 14 | 6.5695 | 0.3000 | | | |
| 15* | 4.1853 | 2.0000 | 1.693500 | 53.20 | |
| 16* | −9.0098 | 0.6230 | | | |
| 17 | 0.0000 | 0.3500 | 1.516800 | 63.88 | |
| 18 | 0.0000 | 0.3500 | | | |
| Image | ∞ | | | | |
| plane | | | | | |

[Focal length of lens groups]

| Lens group | First surface | Focal length |
|---|---|---|
| First lens group G1 | 1 | −5.4519 |
| Second lens group G2 | 12 | 4.7300 |

| | |
|---|---|
| θmax = | 1.920 |
| f11 = | −13.658 |
| f1ne = | −2.786 |
| f22 = | 3.959 |
| f2CL = | −18.969 |

In the optical system OL3, the third surface, the fourth surface, the tenth surface, the eleventh surface, the fifteenth surface, and the sixteenth surface are formed in aspheric shapes. Table 6 below shows aspheric surface data, in other words, the values of the conic constant K and the aspheric surface constants A4 to A10.

TABLE 6
[Aspheric surface data]

| Surface | K | A4 | A6 | A8 | A10 |
|---|---|---|---|---|---|
| 3 | 1.0000 | 2.98171E−04 | −6.83263E−05 | 1.76220E−06 | −1.51294E−08 |
| 4 | 0.3260 | 1.27240E−03 | −6.45956E−06 | −1.19987E−05 | −1.16145E−06 |
| 10 | 1.0000 | −1.80520E−03 | −3.01317E−05 | −2.35563E−04 | 3.85162E−05 |
| 11 | 1.0000 | −1.84399E−03 | −5.69442E−04 | 3.28441E−05 | −1.16331E−05 |
| 15 | 1.0000 | −1.85262E−03 | 7.43786E−05 | −4.48981E−06 | −1.67232E−06 |
| 16 | 1.0000 | 7.54564E−03 | 3.67619E−04 | −1.07258E−04 | 2.91603E−06 |

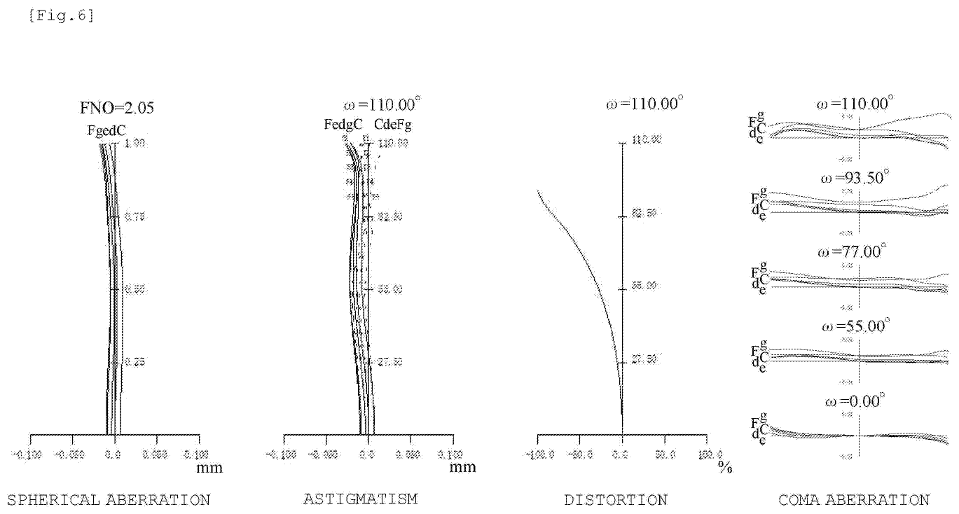

FIG. 6 shows a spherical aberration diagram, an astigmatism diagram, a distortion diagram, and a coma aberration diagram of the optical system OL3. The aberration diagrams show that the optical system OL3 allows favorable correction of the variety of aberrations.

### Fourth Example

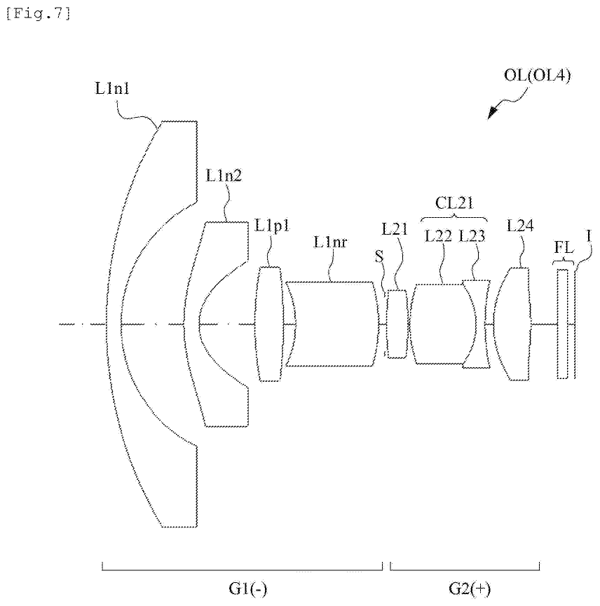

FIG. 7 is a diagram showing the configuration of an optical system OL4 according to a fourth example. The optical system OL4 includes, sequentially from the object side, a first lens group G1 having negative refractive power, an aperture stop S, and a second lens group G2 having positive refractive power.

The first lens group G1 includes, sequentially from the object side, a negative meniscus lens L1n1 having a convex surface facing the object side, an aspheric negative lens L1n2 having a negative meniscus shape with a convex surface facing the object side and having a lens surface in an aspheric shape on the object side and a lens surface in an aspheric shape on the image side, a biconvex positive lens L1p1, and a negative meniscus lens L1nr having a concave surface facing the object side.

The second lens group G2 includes, sequentially from the object side, an aspheric positive lens L21 having a biconvex shape and having a lens surface in an aspheric shape on the object side and a lens surface in an aspheric shape on the image side, a cemented negative lens CL21 formed by cementing a biconvex positive lens L22 and a biconcave negative lens L23, and an aspheric positive lens L24 having a biconvex shape and having a lens surface in an aspheric shape on the object side and a lens surface in an aspheric shape on the image side.

In addition, in the optical system OL4, a filter group FL is disposed between the second lens group G2 and an image plane I.

Table 7 below shows values of specifications of the optical system OL4.

TABLE 7
Fourth example
[Overall specifications]

| | |
|---|---|
| f = | 1.5164 |
| FNO = | 2.0505 |
| 2ω = | 220.000° |
| Y = | 2.8200 |
| BF(air-conversion = | 2.1818 |
| length) | |
| TL(air-conversion = | 25.0318 |
| length) | |

[Lens data]

| m | r | d | nd | vd | |
|---|---|---|---|---|---|
| Object | ∞ | | | | |
| plane | | | | | |
| 1 | 19.9136 | 0.8000 | 1.755000 | 52.33 | |
| 2 | 6.9546 | 3.4000 | | | |
| 3* | 8.8637 | 0.8000 | 1.693500 | 53.20 | |
| 4* | 2.3770 | 3.0000 | | | |
| 5 | 15.5522 | 1.5500 | 1.846660 | 23.80 | |
| 6 | −22.8568 | 0.6500 | | | |
| 7 | −4.8045 | 4.4500 | 1.744000 | 44.80 | |
| 8 | −7.5000 | 0.3500 | | | |
| 9 | 0.0000 | 0.1000 | | | Aperture |
| | | | | | stop S |
| 10* | 12.1641 | 1.1500 | 1.693500 | 53.20 | |
| 11* | −16.0644 | 0.1000 | | | |
| 12 | 6.0359 | 3.5500 | 1.593190 | 67.90 | |
| 13 | −3.3291 | 0.5000 | 1.846660 | 23.80 | |
| 14 | 10.3300 | 0.4500 | | | |
| 15* | 4.7271 | 2.0000 | 1.693500 | 53.20 | |
| 16* | −9.5188 | 1.4493 | | | |
| 17 | 0.0000 | 0.5000 | 1.516800 | 63.88 | |

| | | |
|---|---|---|
| 18 | 0.0000 | 0.4074 |
| Image | ∞ | |
| plane | | |

[Focal length of lens groups]

| Lens group | First surface | Focal length |
|---|---|---|
| First lens group G1 | 1 | −7.7535 |
| Second lens group G2 | 12 | 5.2012 |

| | |
|---|---|
| θmax = | 1.920 |
| f11 = | −14.541 |
| f1ne = | −3.078 |
| f22 = | 4.212 |
| f2CL= | 41.086 |

In the optical system OL4, the third surface, the fourth surface, the tenth surface, the eleventh surface, the fifteenth surface, and the sixteenth surface are formed in aspheric shapes. Table 8 below shows aspheric surface data, in other words, the values of the conic constant K and the aspheric surface constants A4 to A10.

TABLE 8
[Aspheric surface data]

| Surface | K | A4 | A6 | A8 | A10 |
|---|---|---|---|---|---|
| 3 | 1.0000 | −1.50620E−04 | −3.92879E−05 | 6.35169E−07 | −6.75148E−10 |
| 4 | 0.1667 | 2.35877E−03 | −2.95026E−05 | 2.52665E−06 | −9.49568E−07 |
| 10 | 1.0000 | −1.89804E−03 | −2.31147E−05 | −2.02958E−04 | 3.26077E−05 |
| 11 | 1.0000 | −2.00016E−03 | −6.64630E−04 | 1.02708E−04 | −1.84818E−05 |
| 15 | 1.0000 | −6.49048E−04 | −3.92474E−05 | 3.36469E−06 | −1.10787E−06 |
| 16 | 1.0000 | 7.24291E−03 | 1.04078E−04 | −6.73489E−05 | 2.17424E−06 |

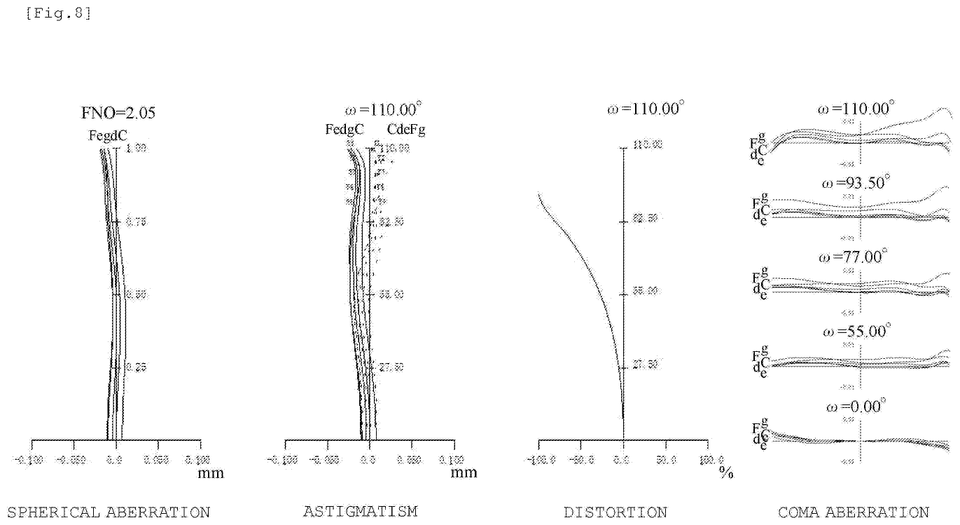

FIG. 8 shows a spherical aberration diagram, an astigmatism diagram, a distortion diagram, and a coma aberration diagram of the optical system OL4. The aberration diagrams show that the optical system OL4 allows favorable correction of the variety of aberrations.

### Fifth Example

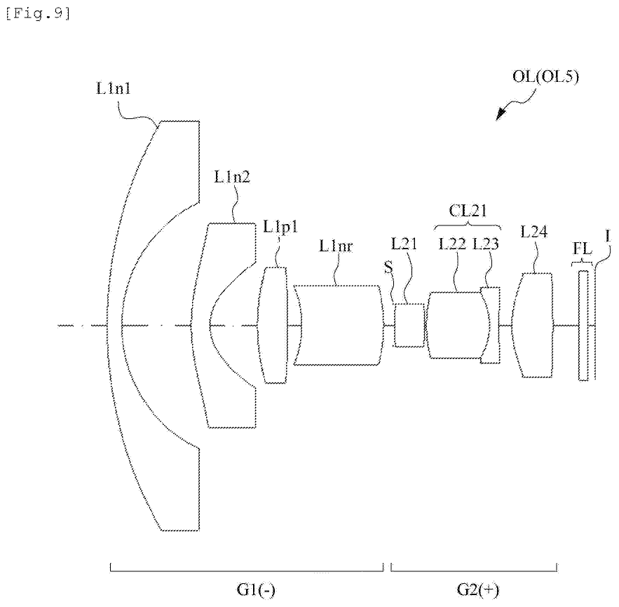

FIG. 9 is a diagram showing the configuration of an optical system OL5 according to a fifth example. The optical system OL5 includes, sequentially from the object side, a first lens group G1 having negative refractive power, an aperture stop S, and a second lens group G2 having positive refractive power.

The first lens group G1 includes, sequentially from the object side, a negative meniscus lens L1n1 having a convex surface facing the object side, an aspheric negative lens L1n2 having a negative meniscus shape with a convex surface facing the object side and having a lens surface in an aspheric shape on the object side and a lens surface in an aspheric shape on the image side, a biconvex positive lens L1p1, and a negative meniscus lens L1nr having a concave surface facing the object side.

The second lens group G2 includes, sequentially from the object side, an aspheric positive lens L21 having a biconvex shape and having a lens surface in an aspheric shape on the object side and a lens surface in an aspheric shape on the image side, a cemented positive lens CL21 formed by cementing a biconvex positive lens L22 and a biconcave negative lens L23, and an aspheric positive lens L24 having a biconvex shape and having a lens surface in an aspheric shape on the object side and a lens surface in an aspheric shape on the image side.

In addition, in the optical system OL5, a filter group FL is disposed between the second lens group G2 and an image plane I.

Table 9 below shows values of specifications of the optical system OL5.

TABLE 9
Fifth example
[Overall specifications]

| | |
|---|---|
| f = | 1.5172 |
| FNO = | 2.8550 |
| 2ω = | 220.000° |
| Y = | 2.8200 |
| BF(air-conversion | 2.1270 |
| length) = | |
| TL(air-conversion | 26.1270 |
| length) = | |

[Lens data]

| m | r | d | nd | vd | |
|---|---|---|---|---|---|
| Object | ∞ | | | | |
| plane | | | | | |
| 1 | 20.8840 | 0.8000 | 1.755000 | 52.33 | |
| 2 | 6.9928 | 3.7500 | | | |
| 3* | 8.9718 | 1.0000 | 1.693500 | 53.20 | |
| 4* | 2.2292 | 2.5500 | | | |
| 5 | 10.7232 | 1.6500 | 1.846660 | 23.80 | |
| 6 | −37.5547 | 0.7500 | | | |
| 7 | −5.0779 | 4.4000 | 1.744000 | 44.80 | |
| 8 | −7.5000 | 0.5000 | | | |
| 9 | 0.0000 | 0.1000 | | | Aperture |
| | | | | | stop S |
| 10* | 15.9252 | 1.6000 | 1.693500 | 53.20 | |
| 11* | −12.9709 | 0.1000 | | | |
| 12 | 6.7056 | 3.4000 | 1.593190 | 67.90 | |
| 13 | −3.1500 | 0.5000 | 1.846660 | 23.80 | |
| 14 | 36.9185 | 0.7000 | | | |
| 15* | 5.2119 | 2.2000 | 1.693500 | 53.20 | |
| 16* | −14.1441 | 1.3982 | | | |
| 17 | 0.0000 | 0.5000 | 1.516800 | 63.88 | |
| 18 | 0.0000 | 0.3991 | | | |
| Image | ∞ | | | | |
| plane | | | | | |

[Focal length of lens groups]

| Lens group | First surface | Focal length |
|---|---|---|
| First lens group G1 | 1 | −7.8550 |
| Second lens group G2 | 12 | 5.2400 |

| | |
|---|---|
| θmax = | 1.920 |
| f11 = | −14.278 |
| f1ne = | −2.805 |
| f22 = | 4.146 |
| f2CL = | 211.611 |

In the optical system OL5, the third surface, the fourth surface, the tenth surface, the eleventh surface, the fifteenth surface, and the sixteenth surface are formed in aspheric shapes. Table 10 below shows aspheric surface data, in other words, the values of the conic constant K and the aspheric surface constants A4 to A10.

TABLE 10
[Aspheric surface data]

| Surface | K | A4 | A6 | A8 | A10 |
|---|---|---|---|---|---|
| 3 | 1.0000 | −1.23301E−03 | 6.33255E−06 | 3.54550E−08 | 3.48869E−10 |
| 4 | −0.0581 | 1.99637E−03 | −2.08791E−04 | 1.74730E−05 | −4.94209E−07 |
| 10 | 1.0000 | −2.92870E−03 | −6.09929E−05 | −2.31535E−04 | 3.61326E−05 |
| 11 | 1.0000 | −2.94869E−03 | −1.22030E−03 | 4.45782E−04 | −9.06419E−05 |
| 15 | 1.0000 | 1.56310E−04 | −4.04787E−04 | 2.26165E−05 | −2.47085E−06 |
| 16 | 1.0000 | 9.67155E−03 | −6.81787E−04 | −5.79352E−05 | 4.00758E−06 |

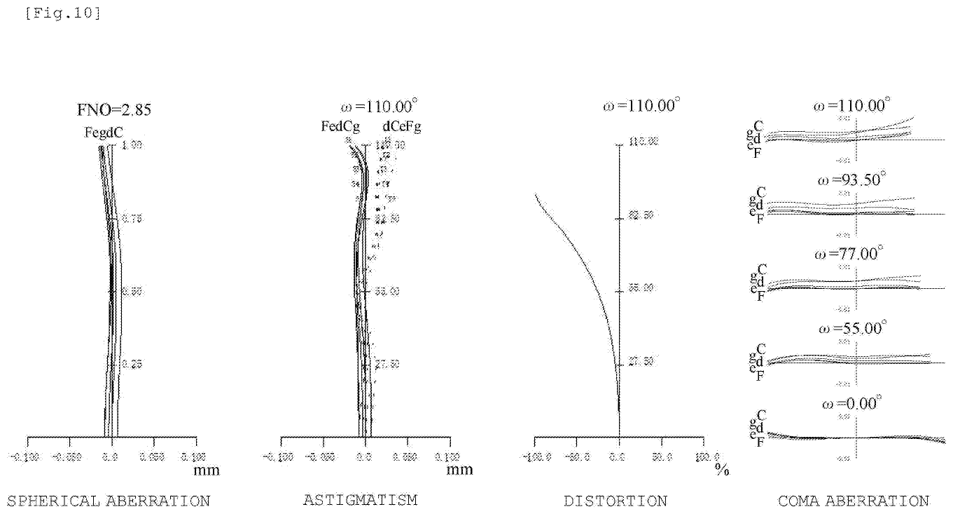

FIG. 10 shows a spherical aberration diagram, an astigmatism diagram, a distortion diagram, and a coma aberration diagram of the optical system OL5. The aberration diagrams show that the optical system OL5 allows favorable correction of the variety of aberrations.

### Sixth Example

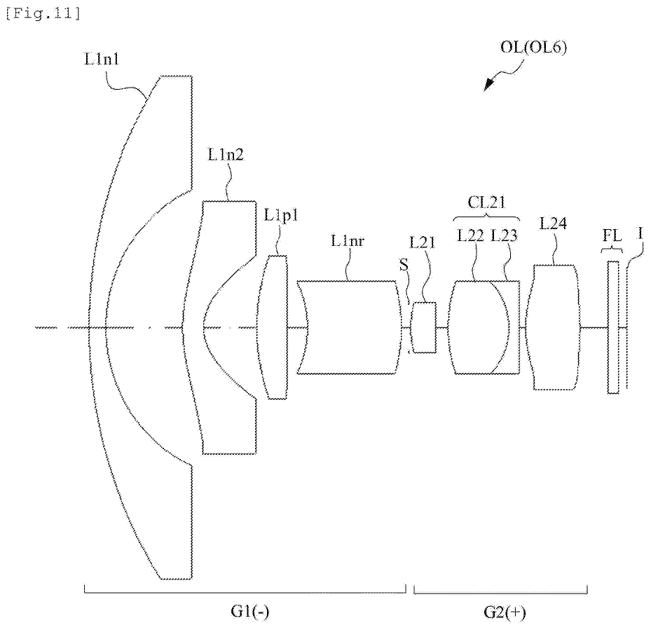

FIG. 11 is a diagram showing the configuration of an optical system OL6 according to a sixth example. The optical system OL6 includes, sequentially from the object side, a first lens group G1 having negative refractive power, an aperture stop S, and a second lens group G2 having positive refractive power.

The first lens group G1 includes, sequentially from the object side, a negative meniscus lens L1n1 having a convex surface facing the object side, an aspheric negative lens L1n2 having a negative meniscus shape with a convex surface facing the object side and having a lens surface in an aspheric shape on the object side and a lens surface in an aspheric shape on the image side, a biconvex positive lens L1p1, and a negative meniscus lens L1nr having a concave surface facing the object side.

The second lens group G2 includes, sequentially from the object side, a positive meniscus lens L21 having a convex surface facing the object side, a cemented positive lens CL21 formed by cementing a biconvex positive lens L22 and a biconcave negative lens L23, and an aspheric positive lens L24 having a biconvex shape and having a lens surface in an aspheric shape on the object side and a lens surface in an aspheric shape on the image side.

In addition, in the optical system OL6, a filter group FL is disposed between the second lens group G2 and an image plane I.

Table 11 below shows values of specifications of the optical system OL6.

TABLE 11
Sixth example
[Overall specifications]

| | |
|---|---|
| f = | 1.5171 |
| FNO = | 2.8276 |
| 2ω = | 220.000° |
| Y = | 2.8200 |
| BF(air-conversion length) = | 2.0611 |
| TL(air-conversion length) = | 25.5855 |

[Lens data]

| m | r | d | nd | νd |
|---|---|---|---|---|
| Object | ∞ | | | |
| plane | | | | |
| 1 | 21.3432 | 0.8000 | 1.755000 | 52.33 |
| 2 | 6.9797 | 3.7052 | | |
| 3* | 7.0838 | 1.0000 | 1.693500 | 53.20 |
| 4* | 2.0272 | 2.5323 | | |
| 5 | 9.5248 | 1.4888 | 1.846660 | 23.80 |
| 6 | −101.5395 | 0.9508 | | |
| 7 | −4.6672 | 4.4950 | 1.744000 | 44.80 |
| 8 | −7.5000 | 0.3527 | | |
| 9 | 0.0000 | 0.1000 | | Aperture stop S |
| 10 | 4.5253 | 1.1772 | 1.589130 | 61.15 |
| 11 | 18.1862 | 0.6039 | | |
| 12 | 6.4547 | 2.9184 | 1.593190 | 67.90 |
| 13 | −3.0003 | 0.5000 | 1.846660 | 23.80 |
| 14 | 259.2911 | 0.3018 | | |
| 15* | 5.3564 | 2.5985 | 1.589130 | 61.15 |
| 16* | −10.7628 | 1.3359 | | |
| 17 | 0.0000 | 0.5000 | 1.516800 | 63.88 |
| 18 | 0.0000 | 0.3955 | | |
| Image | ∞ | | | |
| plane | | | | |

[Focal length of lens group]

| Lens group | First surface | Focal length |
|---|---|---|
| First lens group G1 | 1 | −6.1237 |
| Second lens group G2 | 12 | 5.2825 |
| θmax = 1.920 | | |
| f11 = −14.074 | | |
| f1ne = −2.738 | | |
| f22 = 3.901 | | |
| f2CL = 52.787 | | |

In the optical system OL6, the third surface, the fourth surface, the fifteenth surface, and the sixteenth surface are formed in aspheric shapes. Table 12 below shows aspheric surface data, in other words, the values of the conic constant K and the aspheric surface constants A4 to A10.

TABLE 12
[Aspheric surface data]

| Surface | K | A4 | A6 | A8 | A10 |
|---|---|---|---|---|---|
| 3 | 1.0000 | −2.80653E−03 | 6.18641E−05 | −1.16845E−06 | 8.64204E−09 |
| 4 | −0.0636 | 7.51900E−04 | −4.08990E−04 | 3.85045E−05 | −1.23388E−06 |
| 15 | 1.0000 | −2.65293E−03 | 1.15180E−04 | −1.06286E−04 | 5.22637E−06 |
| 16 | 1.0000 | 7.35654E−03 | 2.11884E−04 | −2.34313E−04 | 1.41715E−05 |

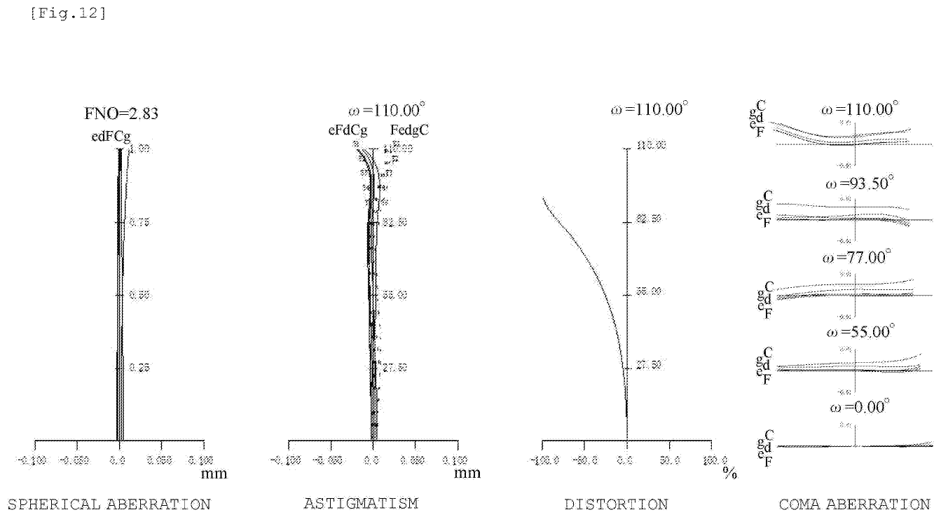

FIG. 12 shows a spherical aberration diagram, an astigmatism diagram, a distortion diagram, and a coma aberration diagram of the optical system OL6. The aberration diagrams show that the optical system OL6 allows favorable correction of the variety of aberrations.

### Seventh Example

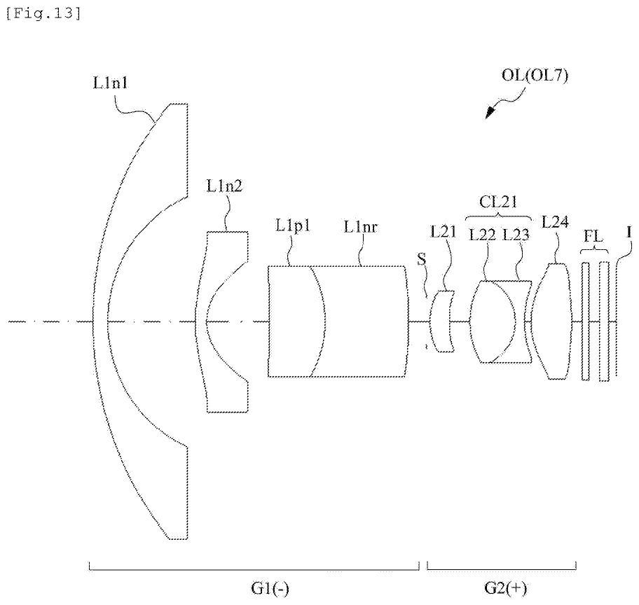

FIG. 13 is a diagram showing the configuration of an optical system OL7 according to a seventh example. The optical system OL7 includes, sequentially from the object side, a first lens group G1 having negative refractive power, an aperture stop S, and a second lens group G2 having positive refractive power.

The first lens group G1 includes, sequentially from the object side, a negative meniscus lens L1n1 having a convex surface facing the object side, an aspheric negative lens L1n2 having a negative meniscus shape with a convex surface facing the object side and having a lens surface in an aspheric shape on the object side and a lens surface in an aspheric shape on the image side, and a cemented positive lens formed by cementing a positive meniscus lens L1p1 having a concave surface facing the object side and a negative meniscus lens L1nr having a concave surface facing the object side.

The second lens group G2 includes, sequentially from the object side, an aspheric positive lens L21 having a positive meniscus shape with a convex surface facing the object side and having a lens surface in an aspheric shape on the object side and a lens surface in an aspheric shape on the image side, a cemented negative lens CL21 formed by cementing a biconvex positive lens L22 and a biconcave negative lens L23, and an aspheric positive lens L24 having a biconvex shape and having a lens surface in an aspheric shape on the object side and a lens surface in an aspheric shape on the image side.

In addition, in the optical system OL7, a filter group FL is disposed between the second lens group G2 and an image plane I.

Table 13 below shows values of specifications of the optical system OL7.

TABLE 13
Seventh example
[Overall specifications]

| | |
|---|---|
| f = | 1.4579 |
| FNO = | 2.8496 |
| 2ω = | 220.000° |
| Y = | 2.8437 |
| BF(air-conversion length) = | 2.1303 |
| TL(air-conversion length) = | 27.8853 |

[Lens data]

| m | r | d | nd | νd |
|---|---|---|---|---|
| Object | ∞ | | | |
| plane | | | | |
| 1 | 17.5161 | 0.8000 | 1.950000 | 29.37 |
| 2 | 7.0574 | 4.7325 | | |
| 3* | 8.2462 | 0.6000 | 1.851348 | 40.10 |
| 4* | 2.3943 | 3.3711 | | |
| 5 | −50.0000 | 3.0000 | 1.846660 | 23.80 |
| 6 | −5.5257 | 4.5000 | 1.744000 | 44.80 |
| 7 | −17.8358 | 0.9498 | | |
| 8 | 0.0000 | 0.1892 | | Aperture stop S |
| 9* | 3.2901 | 1.0330 | 1.693500 | 53.20 |
| 10* | 6.1239 | 1.1026 | | |
| 11 | 4.0530 | 2.4498 | 1.603110 | 60.69 |
| 12 | −2.3500 | 0.5000 | 1.846660 | 23.80 |
| 13 | 5.1035 | 0.3388 | | |
| 14* | 3.6677 | 2.1883 | 1.583130 | 59.46 |
| 15* | −9.0512 | 0.5699 | | |
| 16 | 0.0000 | 0.3500 | 1.516800 | 63.88 |
| 17 | 0.0000 | 0.6000 | | |
| 18 | 0.0000 | 0.5000 | 1.516800 | 63.88 |
| 19 | 0.0000 | 0.4000 | | |
| Image | ∞ | | | |
| plane | | | | |

[Focal length of lens group]

| Lens group | First surface | Focal length |
|---|---|---|
| First lens group G1 | 1 | −4.8669 |
| Second lens group G2 | 12 | 5.6419 |
| θmax = 1.920 | | |
| f11 = −12.923 | | |
| f1ne = −2.442 | | |
| f22 = 2.881 | | |
| f2CL = −17.746 | | |

In the optical system OL7, the third surface, the fourth surface, the ninth surface, the tenth surface, the fourteenth surface, and the fifteenth surface are formed in aspheric shapes. Table 14 below shows aspheric surface data, in other words, the values of the conic constant K and the aspheric surface constants A4 to A10.

TABLE 14
[Aspheric surface data]

| Surface | K | A4 | A6 | A8 | A10 |
|---|---|---|---|---|---|
| 3 | 1.0000 | −1.53300E−03 | −1.73331E−05 | 8.15311E−07 | −7.35247E−09 |
| 4 | 0.0898 | 1.78913E−03 | −1.09198E−04 | 1.15935E−05 | −1.25202E−06 |
| 9 | 1.0000 | 4.88042E−03 | 7.14286E−05 | 5.11387E−04 | −1.27545E−04 |
| 10 | 1.0000 | 9.72711E−03 | −1.08212E−03 | 1.63129E−03 | −3.18887E−04 |
| 14 | 1.0000 | −3.75940E−03 | −4.56881E−04 | 5.94064E−05 | −5.73241E−06 |
| 15 | 1.0000 | 8.65408E−03 | −6.68243E−04 | −1.09279E−05 | −4.60339E−07 |

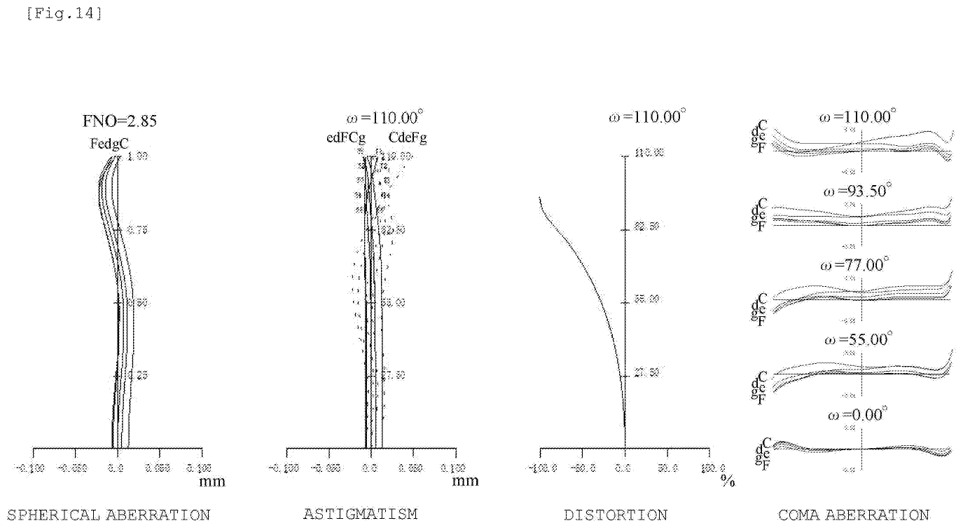

FIG. 14 shows a spherical aberration diagram, an astigmatism diagram, a distortion diagram, and a coma aberration diagram of the optical system OL7. The aberration diagrams show that the optical system OL7 allows favorable correction of the variety of aberrations.

### Eighth Example

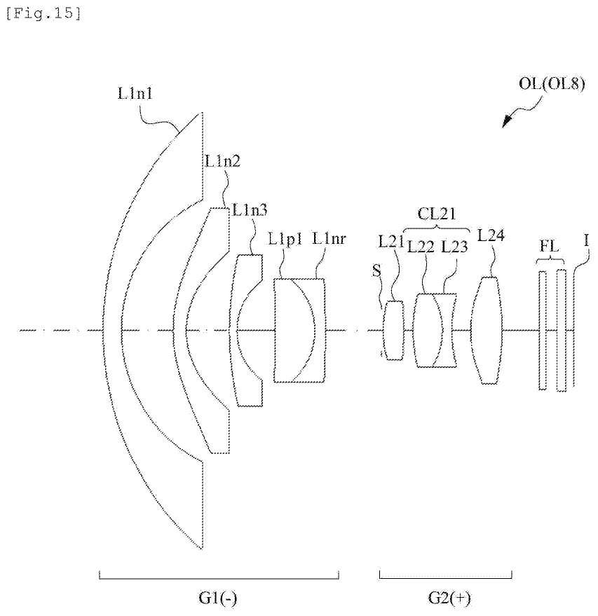

FIG. 15 is a diagram showing the configuration of an optical system OL8 according to an eighth example. The optical system OL8 includes, sequentially from the object side, a first lens group G1 having negative refractive power, an aperture stop S, and a second lens group G2 having positive refractive power.

The first lens group G1 includes, sequentially from the object side, a negative meniscus lens L1n1 having a convex surface facing the object side, an aspheric negative lens L1n2 having a negative meniscus shape with a convex surface facing the object side and having a lens surface in an aspheric shape on the object side and a lens surface in an aspheric shape on the image side, a negative meniscus lens L1n3 having a convex surface facing the object side, and a cemented positive lens formed by cementing a positive meniscus lens L1p1 having a concave surface facing the object side and a negative meniscus lens L1nr having a concave surface facing the object side.

The second lens group G2 includes, sequentially from the object side, a biconvex positive lens L21, a cemented negative lens CL21 formed by cementing a biconvex positive lens L22 and a biconcave negative lens L23, and an aspheric positive lens L24 having a biconvex shape and having a lens surface in an aspheric shape on the object side and a lens surface in an aspheric shape on the image side.

In addition, in the optical system OL8, a filter group FL is disposed between the second lens group G2 and an image plane I.

Table 15 below shows values of specifications of the optical system OL8.

TABLE 15
Eighth example
[Overall specifications]

| | |
|---|---|
| f = | 1.4929 |
| FNO = | 2.8434 |
| 2ω = | 220.000° |
| Y = | 2.9000 |
| BF(air-conversion length) = | 3.5356 |
| TL(air-conversion length) = | 25.0104 |

[Lens data]

| m | r | d | nd | νd |
|---|---|---|---|---|
| Object | ∞ | | | |
| plane | | | | |
| 1 | 14.8108 | 1.0000 | 1.950000 | 29.37 |
| 2 | 7.4757 | 2.7895 | | |
| 3* | 7.2118 | 0.7000 | 1.693500 | 53.20 |
| 4* | 4.0000 | 2.3161 | | |
| 5 | 16.8215 | 0.4000 | 1.834810 | 42.73 |
| 6 | 3.1585 | 2.0592 | | |
| 7 | −80.6011 | 2.1341 | 1.846660 | 23.80 |
| 8 | −3.3939 | 0.5564 | 1.744000 | 44.80 |
| 9 | −61.1866 | 3.0207 | | |
| 10 | 0.0000 | 0.1000 | | Aperture stop S |
| 11 | 5.2705 | 1.0984 | 1.693500 | 53.20 |
| 12 | −15.1553 | 0.5025 | | |
| 13 | 7.2851 | 1.5714 | 1.618000 | 63.34 |
| 14 | −3.5612 | 0.5000 | 1.846660 | 23.80 |
| 15 | 6.9367 | 1.0114 | | |
| 16* | 4.8736 | 1.7151 | 1.618806 | 63.85 |
| 17* | −8.7766 | 1.9752 | | |
| 18 | 0.0000 | 0.3500 | 1.516800 | 63.88 |
| 19 | 0.0000 | 0.6000 | | |
| 20 | 0.0000 | 0.5000 | 1.516800 | 63.88 |
| 21 | 0.000 | 0.4000 | | |
| Image | ∞ | | | |
| plane | | | | |

[Focal length of lens group]

| Lens group | First surface | Focal length |
|---|---|---|
| First lens group G1 | 1 | −2.8222 |
| Second lens group G2 | 12 | 4.9065 |
| θmax = 1.920 | | |
| f11 = −17.020 | | |
| f1ne = −2.194 | | |
| f22 = 4.097 | | |
| f2CL = −11.733 | | |

In the optical system OL8, the third surface, the fourth surface, the sixteenth surface, and the seventeenth surface are formed in aspheric shapes. Table 16 below shows aspheric surface data, in other words, the values of the conic constant K and the aspheric surface constants A4 to A10.

TABLE 16
[Aspheric surface data]

| Surface | K | A4 | A6 | A8 | A10 |
|---|---|---|---|---|---|
| 3 | 1.0000 | −5.86832E−04 | −2.72265E−05 | 7.50879E−07 | −9.58788E−09 |
| 4 | −0.2934 | 1.65410E−03 | −5.10445E−05 | 3.39542E−06 | −1.47897E−07 |
| 16 | 1.0000 | −2.30114E−03 | −3.20673E−04 | 7.06516E−05 | −7.79464E−06 |
| 17 | 1.0000 | 3.74714E−03 | −4.10074E−04 | 7.54658E−05 | −6.25728E−06 |

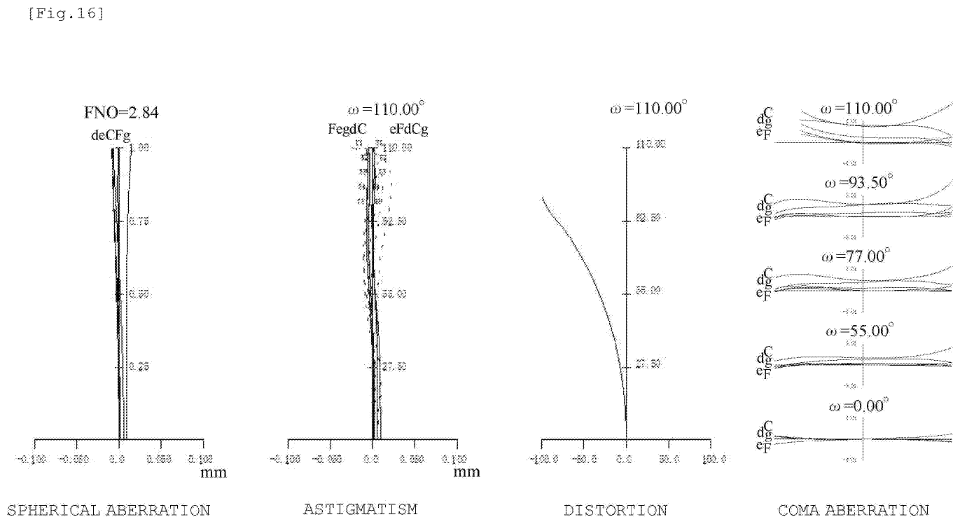

FIG. 16 shows a spherical aberration diagram, an astigmatism diagram, a distortion diagram, and a coma aberration diagram of the optical system OL8. The aberration diagrams show that the optical system OL8 allows favorable correction of the variety of aberrations.

### Ninth Example

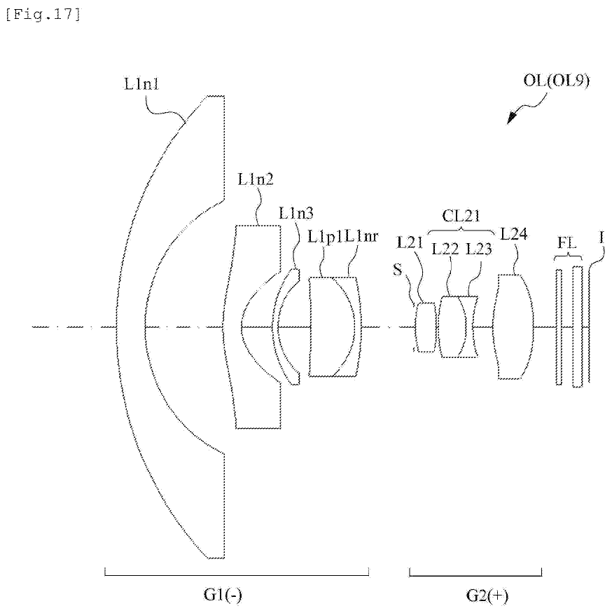

FIG. 17 is a diagram showing the configuration of an optical system OL9 according to a ninth example. The optical system OL9 includes, sequentially from the object side, a first lens group G1 having negative refractive power, an aperture stop S, and a second lens group G2 having positive refractive power.

The first lens group G1 includes, sequentially from the object side, a negative meniscus lens L1n1 having a convex surface facing the object side, an aspheric negative lens L1n2 having a negative meniscus shape with a convex surface facing the object side and having a lens surface in an aspheric shape on the object side and a lens surface in an aspheric shape on the image side, a negative meniscus lens L1n3 having a convex surface facing the object side, and a cemented positive lens formed by cementing a positive meniscus lens L1p1 having a concave surface facing the object side and a negative meniscus lens L1nr having a concave surface facing the object side.

The second lens group G2 includes, sequentially from the object side, a biconvex positive lens L21, a cemented negative lens CL21 formed by cementing a biconvex positive lens L22 and a biconcave negative lens L23, and an aspheric positive lens L24 having a biconvex shape and having a lens surface in an aspheric shape on the object side and a lens surface in an aspheric shape on the image side.

In addition, in the optical system OL9, a filter group FL is disposed between the second lens group G2 and an image plane I.

Table 17 below shows values of specifications of the optical system OL9.

TABLE 17
Ninth example
[Overall specifications]

| | |
|---|---|
| f = | 1.4800 |
| FNO = | 2.8400 |
| 2ω = | 220.000° |
| Y = | 2.9000 |
| BF(air-conversion length) = | 2.7363 |
| TL(air-conversion length) = | 25.2274 |

[Lens data]

| m | r | d | nd | νd |
|---|---|---|---|---|
| Object | ∞ | | | |
| plane | | | | |
| 1 | 17.1091 | 1.5500 | 2.001000 | 29.12 |
| 2 | 7.2020 | 4.2000 | | |
| 3* | 6.9915 | 1.0000 | 1.693500 | 53.20 |
| 4* | 2.1173 | 1.6649 | | |
| 5 | 4.8359 | 0.3000 | 1.618000 | 63.34 |
| 6 | 3.0941 | 1.7673 | | |
| 7 | −43.2909 | 2.3612 | 1.755200 | 27.57 |
| 8 | −3.2807 | 0.3500 | 1.618000 | 63.34 |
| 9 | −11.4320 | 2.8276 | | |
| 10 | 0.0000 | 0.1000 | | Aperture stop S |
| 11 | 4.8922 | 1.1311 | 1.497103 | 81.56 |
| 12 | −6.7985 | 0.1000 | | |
| 13 | 6.3261 | 1.5023 | 1.618000 | 63.34 |
| 14 | −2.9500 | 0.3500 | 1.755200 | 27.57 |
| 15 | 4.7002 | 1.086 | | |
| 16* | 4.9645 | 2.2000 | 1.497103 | 81.56 |
| 17* | −6.5161 | 1.2089 | | |
| 18 | 0.0000 | 0.3000 | 1.516800 | 63.88 |
| 19 | 0.0000 | 0.6000 | | |
| 20 | 0.0000 | 0.5000 | 1.516800 | 63.88 |
| 21 | 0.000 | 0.4000 | | |
| Image | ∞ | | | |
| plane | | | | |

[Focal length of lens group]

| Lens group | First surface | Focal length |
|---|---|---|
| First lens group G1 | 1 | −4.9339 |
| Second lens group G2 | 12 | 5.1951 |
| θmax = 1.920 | | |
| f11 = −13.480 | | |
| f1ne = −2.045 | | |
| f22 = 3.470 | | |
| f2CL = −11.245 | | |

In the optical system OL9, the third surface, the fourth surface, the sixteenth surface, and the seventeenth surface are formed in aspheric shapes. Table 18 below shows aspheric surface data, in other words, the values of the conic constant K and the aspheric surface constants A4 to A10.

TABLE 18
[Aspheric surface data]

| Surface | K | A4 | A6 | A8 | A10 |
|---|---|---|---|---|---|
| 3 | 1.0000 | −3.82534E−03 | 9.87591E−05 | −1.53976E−06 | 5.41980E−09 |
| 4 | 0.0967 | 6.98162E−04 | −4.10149E−04 | 7.30490E−05 | −3.60898E−06 |
| 16 | −3.8433 | −1.71127E−03 | −3.73520E−04 | −7.71767E−05 | 9.63814E−06 |
| 17 | 1.0000 | −4.18174E−04 | −2.54824E−04 | −7.20386E−05 | 8.77599E−06 |

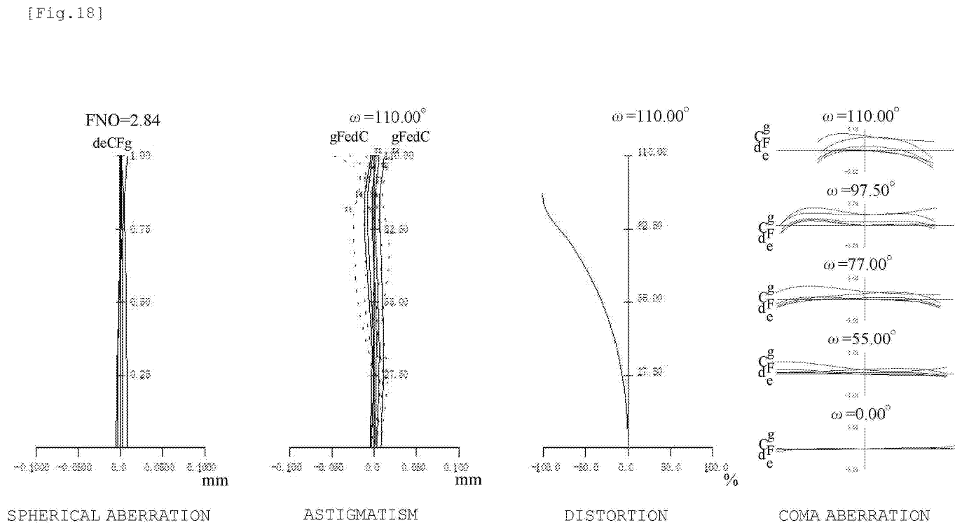

FIG. 18 shows a spherical aberration diagram, an astigmatism diagram, a distortion diagram, and a coma aberration diagram of the optical system OL9. The aberration diagrams show that the optical system OL9 allows favorable correction of the variety of aberrations.

### Tenth Example

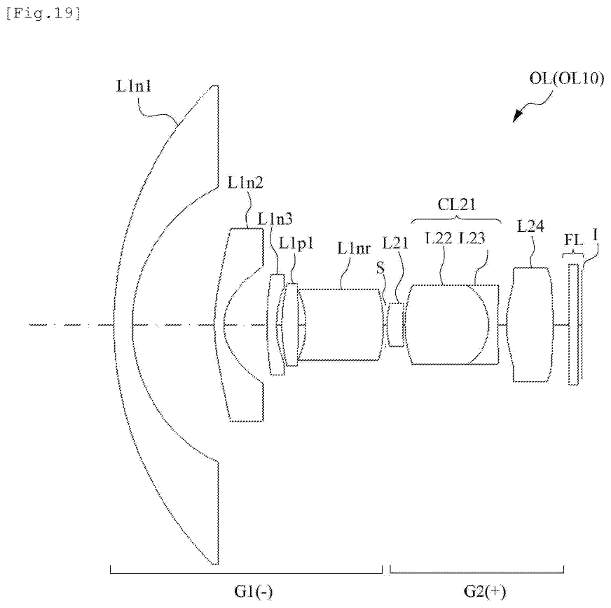

FIG. 19 is a diagram showing the configuration of an optical system OL10 according to a tenth example. The optical system OL10 includes, sequentially from the object side, a first lens group G1 having negative refractive power, an aperture stop S, and a second lens group G2 having positive refractive power.

The first lens group G1 includes, sequentially from the object side, a negative meniscus lens L1n1 having a convex surface facing the object side, an aspheric negative lens L1n2 having a negative meniscus shape with a convex surface facing the object side and having a lens surface in an aspheric shape on the object side and a lens surface in an aspheric shape on the image side, a negative meniscus lens L1n3 having a convex surface facing the object side, a biconvex positive lens L1p1, and a negative meniscus lens L1nr having a concave surface facing the object side.

The second lens group G2 includes, sequentially from the object side, a positive meniscus lens L21 having a convex surface facing the object side, a cemented positive lens CL21 formed by cementing a biconvex positive lens L22 and a biconcave negative lens L23, and an aspheric positive lens L24 having a biconvex shape and having a lens surface in an aspheric shape on the object side and a lens surface in an aspheric shape on the image side.

In addition, in the optical system OL10, a filter group FL is disposed between the second lens group G2 and an image plane I.

Table 19 below shows values of specifications of the optical system OL10.

TABLE 19
Tenth example
[Overall specifications]

| | |
|---|---|
| f = | 1.4900 |
| FNO = | 2.8500 |
| 2ω = | 220.000° |
| Y = | 2.8576 |
| BF(air-conversion length) = | 1.3763 |
| TL(air-conversion length) = | 25.0121 |

[Lens data]

| m | r | d | nd | νd |
|---|---|---|---|---|
| Object | ∞ | | | |
| plane | | | | |
| 1 | 17.1591 | 1.0000 | 1.785900 | 44.17 |
| 2 | 7.8248 | 4.4221 | | |
| 3* | 8.0479 | 0.5000 | 1.693500 | 53.20 |
| 4* | 2.3855 | 2.3262 | | |
| 5 | 16.6969 | 0.5000 | 1.755000 | 52.33 |
| 6 | 4.7801 | 0.3106 | | |
| 7 | 8.4202 | 0.8718 | 1.846660 | 23.80 |
| 8 | −37.3162 | 0.4112 | | |
| 9 | −4.0477 | 4.1728 | 1.744000 | 44.80 |
| 10 | −5.9514 | 0.1000 | | |
| 11 | 0.0000 | 0.1000 | | Aperture stop S |
| 12 | 4.4674 | 0.8611 | 1.497103 | 81.56 |
| 13 | 37.4181 | 0.1000 | | |
| 14 | 5.5996 | 4.5000 | 1.593190 | 67.90 |
| 15 | −2.3765 | 0.5000 | 1.846660 | 23.80 |
| 16 | 65.2616 | 0.4600 | | |
| 17* | 5.1140 | 2.5000 | 1.693500 | 53.20 |
| 18* | −11.1378 | 0.8432 | | |
| 19 | 0.0000 | 0.5000 | 1.516800 | 63.88 |
| 20 | 0.0000 | 0.2035 | | |
| Image | ∞ | | | |
| plane | | | | |

[Focal length of lens group]

| Lens group | First surface | Focal length |
|---|---|---|
| First lens group G1 | 1 | −5.3604 |
| Second lens group G2 | 12 | 5.3544 |
| θmax = 1.920 | | |
| f11 = −19.208 | | |
| f1ne = −1.943 | | |
| f22 = 3.561 | | |
| f2CL = 45.028 | | |

In the optical system OL10, the third surface, the fourth surface, the seventeenth surface, and the eighteenth surface are formed in aspheric shapes. Table 20 below shows aspheric surface data, in other words, the values of the conic constant K and the aspheric surface constants A4 to A10.

TABLE 20
[Aspheric surface data]

| Surface | K | A4 | A6 | A8 | A10 |
|---|---|---|---|---|---|
| 3 | 1.0000 | −2.48190E−03 | 6.15029E−05 | −1.00012E−06 | 1.03262E−08 |
| 4 | 0.0045 | 2.61547E−03 | −3.07485E−04 | 3.80970E−05 | −1.27252E−06 |
| 17 | 1.0000 | −4.03506E−03 | 6.02948E−05 | −7.66319E−05 | −1.36044E−07 |
| 18 | 1.0000 | 7.35654E−03 | 2.11884E−04 | −2.34313E−04 | 1.41715E−05 |

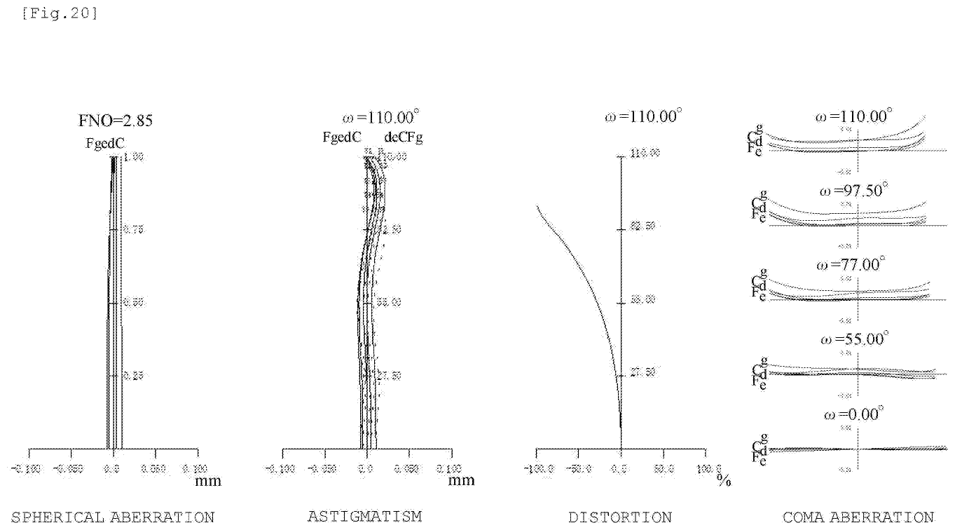

FIG. 20 shows a spherical aberration diagram, an astigmatism diagram, a distortion diagram, and a coma aberration diagram of the optical system OL10. The aberration diagrams show that the optical system OL10 allows favorable correction of the variety of aberrations.

### Eleventh Example

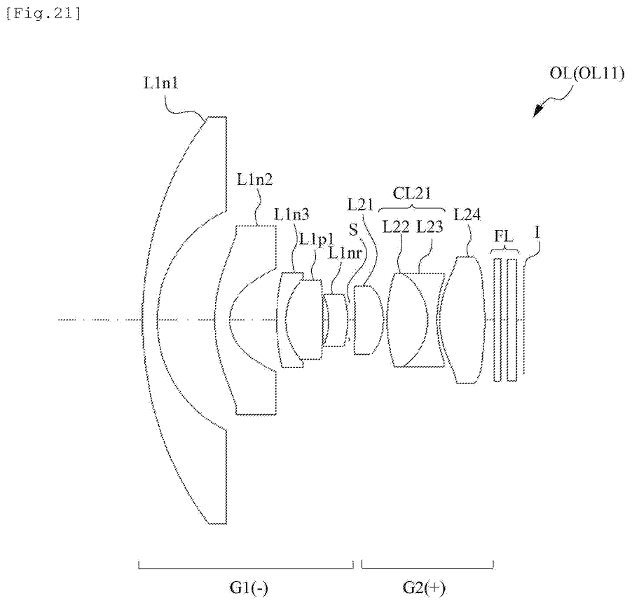

FIG. 21 is a diagram showing the configuration of an optical system OL11 according to an eleventh example. The optical system OL11 includes, sequentially from the object side, a first lens group G1 having negative refractive power, an aperture stop S, and a second lens group G2 having positive refractive power.

The first lens group G1 includes, sequentially from the object side, a negative meniscus lens L1n1 having a convex surface facing the object side, an aspheric negative lens L1n2 having a negative meniscus shape with a convex surface facing the object side and having a lens surface in an aspheric shape on the object side and a lens surface in an aspheric shape on the image side, a cemented positive lens formed by cementing a negative meniscus lens L1n3 having a convex surface facing the object side and a biconvex positive lens L1p1, and a negative meniscus lens L1nr having a concave surface facing the object side.

The second lens group G2 includes, sequentially from the object side, an aspheric positive lens L21 having a positive meniscus shape with a concave surface facing the object side and having a lens surface in an aspheric shape on the object side and a lens surface in an aspheric shape on the image side, a cemented negative lens CL21 formed by cementing a biconvex positive lens L22 and a biconcave negative lens L23, and an aspheric positive lens L24 having a biconvex shape and having a lens surface in an aspheric shape on the object side and a lens surface in an aspheric shape on the image side.

In addition, in the optical system OL11, a filter group FL is disposed between the second lens group G2 and an image plane I.

Table 21 below shows values of specifications of the optical system OL11.

TABLE 21
Eleventh example
[Overall specifications]

| | |
|---|---|
| f = | 1.4036 |
| FNO = | 2.5144 |
| 2ω = | 220.000° |
| Y = | 2.8258 |
| BF(air-conversion length) = | 1.8104 |
| TL(air-conversion length) = | 20.2494 |

[Lens data]

| m | r | d | nd | νd |
|---|---|---|---|---|
| Object | ∞ | | | |
| plane | | | | |
| 1 | 17.3921 | 0.8000 | 1.755000 | 52.33 |
| 2 | 6.2191 | 3.1042 | | |
| 3* | 7.8489 | 0.8000 | 1.693500 | 53.20 |
| 4* | 1.8910 | 2.5247 | | |
| 5 | 9.9863 | 0.5000 | 1.744000 | 44.80 |
| 6 | 3.0000 | 2.0000 | 1.698950 | 30.13 |
| 7 | −19.1339 | 0.2990 | | |
| 8 | −3.1620 | 1.0186 | 1.744000 | 44.80 |
| 9 | −4.2436 | 0.1000 | | |
| 10 | 0.0000 | 0.2922 | | Aperture stop S |
| 11* | −206.3954 | 1.5342 | 1.693500 | 53.20 |
| 12* | −3.1485 | 0.2035 | | |
| 13 | 7.6355 | 2.1691 | 1.593190 | 67.90 |
| 14 | −2.8501 | 0.5000 | 1.846660 | 23.80 |
| 15 | 6.3001 | 0.1543 | | |
| 16* | 4.3183 | 2.4393 | 1.693500 | 53.20 |
| 17* | −8.4972 | 0.5000 | | |
| 18 | 0.0000 | 0.3500 | 1.516800 | 63.88 |
| 19 | 0.0000 | 0.3500 | | |
| 20 | 0.0000 | 0.5000 | 1.516800 | 63.88 |
| 21 | 0.0000 | 0.4000 | | |
| Image | ∞ | | | |
| plane | | | | |

[Focal length of lens group]

| Lens group | First surface | Focal length |
|---|---|---|
| First lens group G1 | 1 | −3.8708 |
| Second lens group G2 | 12 | 3.8529 |
| θmax = 1.920 | | |
| f11 = −13.230 | | |
| f1ne = −1.231 | | |
| f22 = 3.791 | | |
| f2CL = −8.191 | | |

In the optical system OL11, the third surface, the fourth surface, the eleventh surface, the twelfth surface, the sixteenth surface, and the seventeenth surface are formed in aspheric shapes. Table 22 below shows aspheric surface data, in other words, the values of the conic constant K and the aspheric surface constants A4 to A10.

TABLE 22
[Aspheric surface data]

| Surface | K | A4 | A6 | A8 | A10 |
|---|---|---|---|---|---|
| 3 | 1.0000 | 8.18147E−04 | −9.92439E−05 | 1.13263E−06 | 1.18156E−08 |
| 4 | 0.1008 | 6.24128E−03 | 7.86490E−04 | 4.47755E−05 | −1.42494E−05 |
| 11 | 1.0000 | −1.64413E−02 | 1.89009E−03 | −5.74381E−03 | 1.28777E−03 |
| 12 | 1.0000 | −6.80151E−03 | −1.47691E−03 | 1.37426E−05 | −1.30455E−04 |
| 16 | 1.0000 | −2.77670E−03 | −6.22095E−05 | 1.03640E−05 | −2.58203E−06 |
| 17 | 1.0000 | 8.89836E−03 | −4.97370E−04 | −4.99130E−05 | 2.06768E−06 |

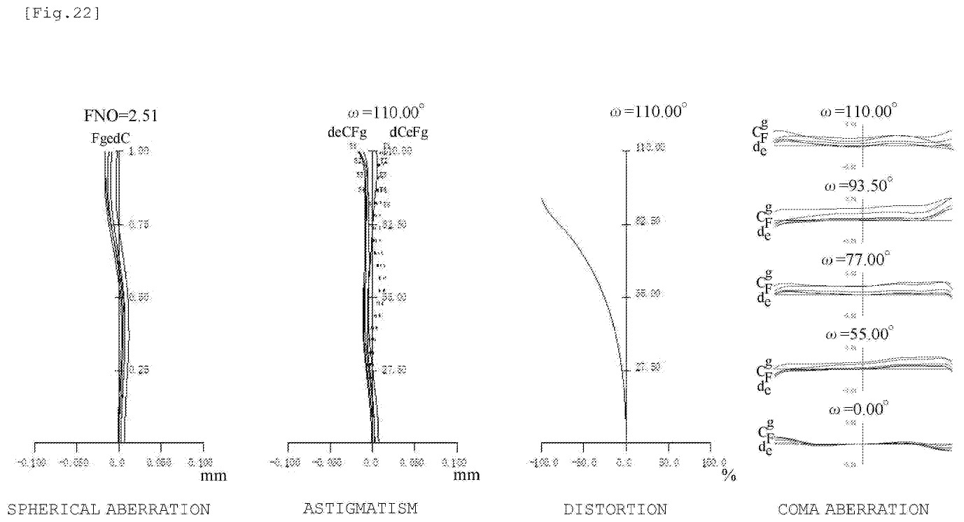

FIG. 22 shows a spherical aberration diagram, an astigmatism diagram, a distortion diagram, and a coma aberration diagram of the optical system OL11. The aberration diagrams show that the optical system OL11 allows favorable correction of the variety of aberrations.

### Twelfth Example

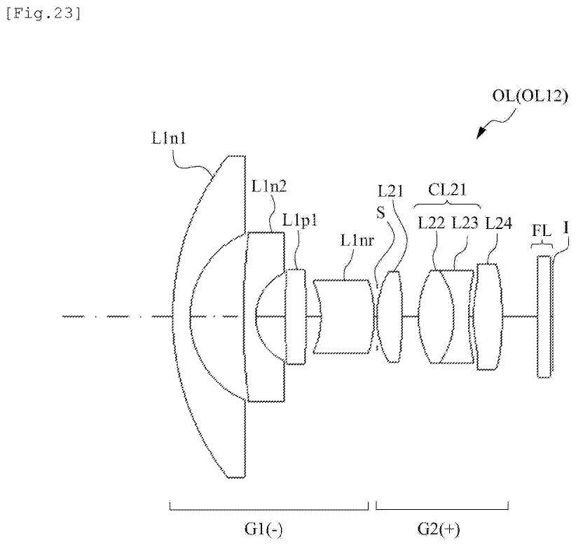

FIG. 23 is a diagram showing the configuration of an optical system OL12 according to a twelfth example. The optical system OL12 includes, sequentially from the object side, a first lens group G1 having negative refractive power, an aperture stop S, and a second lens group G2 having positive refractive power.

The first lens group G1 includes, sequentially from the object side, a negative meniscus lens L1n1 having a convex surface facing the object side, a negative meniscus lens L1n2 having a convex surface facing the object side, a biconvex positive lens L1p1, and a negative meniscus lens L1nr having a concave surface facing the object side.

The second lens group G2 includes, sequentially from the object side, a biconvex positive lens L21, a cemented negative lens CL21 formed by cementing a biconvex positive lens L22 and a biconcave negative lens L23, and an aspheric positive lens L24 having a biconvex shape and having a lens surface in an aspheric shape on the object side and a lens surface in an aspheric shape on the image side.

In addition, in the optical system OL12, a filter group FL is disposed between the second lens group G2 and an image plane I.

Table 23 below shows values of specifications of the optical system OL12.

TABLE 23
Twelfth example
[Overall specifications]

| | |
|---|---|
| f = | 1.3278 |
| FNO = | 2.0198 |
| 2ω = | 220.000° |
| Y = | 2.1690 |
| BF(air-conversion length) = | 1.8800 |
| TL(air-conversion length) = | 15.2622 |

[Lens data]

| m | r | d | nd | νd |
|---|---|---|---|---|
| Object | ∞ | | | |
| plane | | | | |
| 1 | 10.0599 | 0.7000 | 1.772503 | 49.46 |
| 2 | 3.5000 | 2.1596 | | |
| 3 | 26.6897 | 0.5000 | 1.496997 | 81.61 |
| 4 | 1.8646 | 1.1982 | | |
| 5 | 22.8263 | 0.8593 | 1.846660 | 23.80 |
| 6 | −23.2027 | 0.5946 | | |
| 7 | −3.2274 | 2.1627 | 1.744000 | 44.80 |
| 8 | −4.1971 | 0.1000 | | |
| 9 | 0.0000 | 0.0000 | | Aperture stop S |
| 10 | 3.4333 | 1.0581 | 1.518600 | 69.89 |
| 11 | −10.3553 | 0.6438 | | |
| 12 | 3.5801 | 1.4413 | 1.496997 | 81.61 |
| 13 | −3.0542 | 0.6000 | 1.846660 | 23.80 |
| 14 | 7.8302 | 0.1813 | | |
| 15* | 4.7406 | 1.1834 | 1.772503 | 49.46 |
| 16* | −10.6333 | 1.4500 | | |
| 17 | 0.0000 | 0.5000 | 1.516800 | 63.88 |
| 18 | 0.0000 | 0.1003 | | |
| Image | ∞ | | | |
| plane | | | | |

[Focal length of lens group]

| Lens group | First surface | Focal length |
|---|---|---|
| First lens group G1 | 1 | −3.9397 |
| Second lens group G2 | 12 | 3.6107 |
| θmax = 1.745 | | |
| f11 = −7.287 | | |
| f1ne = −2.168 | | |
| f22 = 3.574 | | |
| f2CL = −18.995 | | |

In the optical system OL12, the fifteenth surface, and the sixteenth surface are formed in aspheric shapes. Table 24 below shows aspheric surface data, in other words, the values of the conic constant K and the aspheric surface constants A4 to A10.

TABLE 24
[Aspheric surface data]

| Surface | K | A4 | A6 | A8 | A10 |
|---|---|---|---|---|---|
| 15 | 1.0000 | −1.10596E−02 | −7.54188E−04 | −8.15640E−06 | −8.34871E−05 |
| 16 | 1.0000 | 2.60057E−03 | −9.57889E−04 | −3.37294E−05 | −1.05625E−05 |

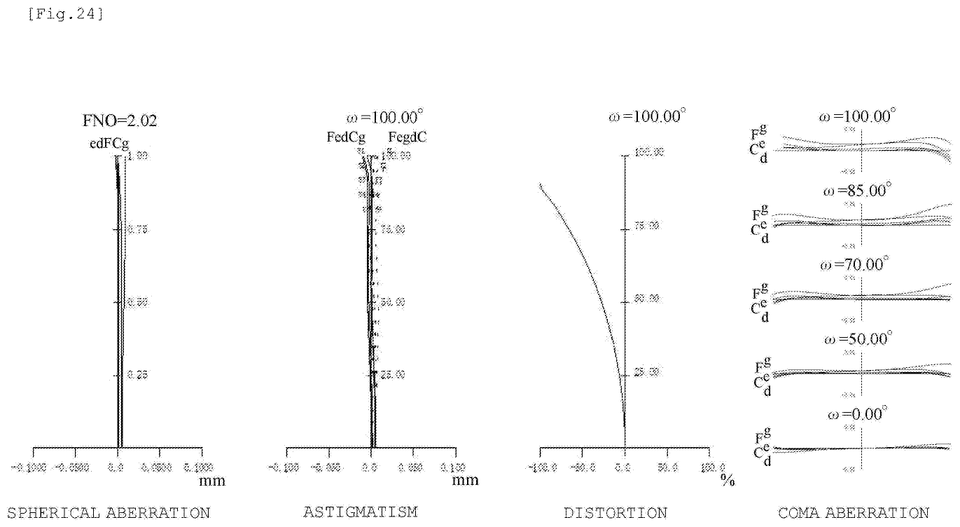

FIG. 24 shows a spherical aberration diagram, an astigmatism diagram, a distortion diagram, and a coma aberration diagram of the optical system OL12. The aberration diagrams show that the optical system OL11 allows favorable correction of the variety of aberrations.

The numerical values of Conditional Expressions (1) to (23) in the first example (optical system OL1) to the twelfth example (optical system OL12) are shown below.

(1) ωmax

(2) (−f1)/θmax

(3) D12/(−f1)

(4) (Lnr1−Lpr2)/(Lnr1+Lpr2)

(5) (−f1)/f2

(6) Dn/f

(7) Dn/(−f1)

(8) (−f1)/f

(9) f2/f

(10) D12/(−f11)

(11) DS/(−f1)

(12) DS/(−f11)

(13) (L1r2−L1r1)/(L1r2+L1r1)

(14) TL/f

(15) BF/f

(16)/D1/f

(17)/D2/f

(18) (−f1ne)/f

(19) f22/f

(20) f2CL/(−f1)

(21) (−f1ne)/θmax

(22) νda

(23) (L3r1−L2r2)/(L3r1+L2r2)

| | Example 1 | Example 2 | Example 3 | Example 4 | Example 5 | Example 6 |
|---|---|---|---|---|---|---|
| (1) | 110.00 | 110.00 | 110.00 | 110.00 | 110.00 | 110.00 |
| (2) | 2.680 | 2.463 | 2.840 | 4.039 | 4.091 | 3.190 |
| (3) | 0.806 | 0.719 | 0.624 | 0.439 | 0.477 | 0.605 |
| (4) | −0.698 | −0.568 | −0.593 | −0.653 | −0.762 | −0.912 |
| (5) | 1.037 | 0.975 | 1.153 | 1.491 | 1.499 | 1.159 |
| (6) | 2.339 | 2.347 | 2.713 | 2.935 | 2.900 | 2.963 |
| (7) | 0.690 | 0.719 | 0.679 | 0.574 | 0.560 | 0.734 |
| (8) | 3.390 | 3.263 | 3.998 | 5.113 | 5.177 | 4.036 |
| (9) | 3.270 | 3.348 | 3.468 | 3.430 | 3.454 | 3.482 |
| (10) | 0.287 | 0.261 | 0.249 | 0.234 | 0.263 | 0.263 |
| (11) | 0.097 | 0.095 | 0.083 | 0.058 | 0.076 | 0.074 |
| (12) | 0.035 | 0.035 | 0.033 | 0.031 | 0.042 | 0.032 |
| (13) | −0.489 | −0.500 | −0.486 | −0.482 | −0.498 | −0.507 |
| (14) | 16.583 | 16.233 | 17.222 | 16.508 | 17.220 | 16.864 |
| (15) | 1.363 | 1.358 | 1.420 | 1.439 | 1.402 | 1.359 |
| (16) | 9.389 | 9.146 | 10.119 | 9.661 | 9.821 | 9.869 |
| (17) | 5.501 | 5.419 | 5.353 | 5.111 | 5.602 | 5.339 |
| (18) | 1.582 | 1.978 | 2.043 | 2.030 | 1.848 | 1.804 |
| (19) | 2.791 | 2.725 | 2.903 | 2.777 | 2.732 | 2.571 |
| (20) | 38.514 | −5.188 | −3.479 | −5.299 | 26.940 | 8.620 |
| (21) | 1.251 | 1.492 | 1.451 | 1.603 | 1.461 | 1.426 |
| (22) | 52.760 | 52.780 | 52.765 | 52.765 | 52.765 | 52.765 |
| (23) | 0.659 | 0.837 | 0.764 | 0.735 | 0.656 | 0.649 |
| | Example 7 | Example 8 | Example 9 | Example 10 | Example 11 | Example 12 |
| (1) | 110.00 | 110.00 | 110.00 | 110.00 | 110.00 | 100.00 |
| (2) | 2.535 | 1.470 | 2.570 | 2.792 | 2.016 | 2.257 |
| (3) | 0.972 | 0.988 | 0.851 | 0.825 | 0.802 | 0.548 |
| (4) | 0.000 | 0.000 | 0.000 | −0.804 | −0.716 | −0.756 |
| (5) | 0.863 | 0.575 | 0.950 | 1.001 | 1.005 | 1.091 |
| (6) | 3.087 | 0.373 | 0.236 | 2.801 | 0.726 | 1.629 |
| (7) | 0.925 | 0.197 | 0.071 | 0.778 | 0.263 | 0.549 |
| (8) | 3.338 | 1.890 | 3.334 | 3.598 | 2.758 | 2.967 |
| (9) | 3.870 | 3.287 | 3.510 | 3.594 | 2.745 | 2.719 |
| (10) | 0.366 | 0.164 | 0.312 | 0.230 | 0.235 | 0.296 |
| (11) | 0.234 | 1.106 | 0.593 | 0.037 | 0.101 | 0.025 |
| (12) | 0.088 | 0.183 | 0.217 | 0.010 | 0.030 | 0.014 |
| (13) | −0.426 | −0.329 | −0.408 | −0.374 | −0.473 | −0.484 |
| (14) | 19.127 | 16.753 | 17.046 | 16.787 | 14.426 | 11.495 |
| (15) | 1.461 | 2.368 | 1.849 | 0.924 | 1.290 | 1.416 |
| (16) | 11.663 | 8.008 | 8.914 | 9.741 | 7.870 | 6.156 |
| (17) | 5.221 | 4.286 | 4.304 | 5.987 | 4.987 | 3.847 |
| (18) | 1.675 | 1.470 | 1.382 | 1.304 | 0.877 | 1.633 |
| (19) | 1.976 | 2.744 | 2.345 | 2.390 | 2.701 | 2.692 |
| (20) | −3.646 | −4.157 | −2.279 | 8.400 | −2.116 | −4.821 |
| (21) | 1.272 | 1.143 | 1.065 | 1.012 | 0.641 | 1.242 |
| (22) | 34.735 | 41.767 | 48.553 | 49.900 | 50.110 | 65.535 |
| (23) | 1.101 | 0.616 | 0.391 | 0.750 | 0.682 | 0.849 |

### REFERENCE SIGNS LIST

1 camera (optical apparatus)
OL (OL1 to OL12) optical system
G1 first lens group
G2 second lens group
L1n1, L1n2, L1n3 negative lens
L1p1 positive lens
L1nr back-side negative lens

1. An optical system comprising,
sequentially from an object side:
a first lens group;
an aperture stop; and
a second lens group, wherein
the first lens group includes, sequentially from the object side,
at least two negative lenses,
a positive lens, and
a back-side negative lens, and
the optical system satisfies the following conditional expression:
90.00°<ωmax
where
ωmax: maximum value [°] of a half angle of view of the optical system.

2. An optical system comprising, sequentially from an object side:
a first lens group;
an aperture stop; and
a second lens group, wherein
the first lens group includes, sequentially from the object side,
at least two negative lenses,
a positive lens, and
a back-side negative lens, and
the optical system satisfies the following conditional expression:
0.300<(−f1)/θmax<9.200
where
f1: focal length of the first lens group, and
θmax: maximum value [radian] of a half angle of view of the optical system.

3. An optical system comprising, sequentially from an object side:
a first lens group;
an aperture stop; and
a second lens group, wherein
the first lens group includes, sequentially from the object side,
at least two negative lenses,
a positive lens, and
a back-side negative lens, and
the optical system satisfies the following conditional expression:
0.280<D12/(−f1)<1.200
where
D12: distance on an optical axis between the two negative lenses disposed closest to the object side in the first lens group, and
f1: focal length of the first lens group.

4. The optical system according to claim 1, wherein the optical system satisfies the following conditional expression:
10.000<(Lnr1−Lpr2)/(Lnr1+Lpr2)≤0.000
where
Lpr2: radius of curvature of a lens surface of the positive lens on an image side, and
Lnr1: radius of curvature of a lens surface of the back-side negative lens on the object side.

5. The optical system according to claim 1, wherein the optical system satisfies the
0.200<(−f1)/f2<4.500
where
f1: focal length of the first lens group, and
f2: focal length of the second lens group.

6. The optical system according to claim 1, wherein the optical system satisfies the
0.130<Dn/f<3.500
where
Dn: thickness of a negative lens on an optical axis, the negative lens being disposed closest to an image side among negative lenses included in the first lens group, and
f: overall focal length of the optical system.

7. The optical system according to claim 1, wherein the optical system satisfies the following conditional expression:
0.020<Dn/(−f1)<1.500
where
Dn: thickness of a negative lens on an optical axis, the negative lens being disposed closest to an image side among negative lenses included in the first lens group, and
f1: focal length of the first lens group.

8. The optical system according to claim 1, wherein the optical system satisfies the following conditional expression:
1.000<(−f1)/f<7.000
where
f1: focal length of the first lens group, and
f: overall focal length of the optical system.

9. The optical system according to claim 1, wherein the optical system satisfies the following conditional expression:
2.500<f2/f<4.500
f2: focal length of the second lens group, and
f: overall focal length of the optical system.

10. The optical system according to claim 1, wherein the optical system satisfies the following conditional expression:
0.100<D12/(−f11)<0.500
where
D12: distance on an optical axis between the two negative lenses disposed closest to the object side in the first lens group, and
f11: focal length of a negative lens disposed closest to the object side in the first lens group.

11. The optical system according to claim 1, wherein the optical system satisfies the following conditional expression:
0.015<DS/(−f1)<1.500
DS: distance on an optical axis from a lens surface closest to an image side in the first lens group to a lens surface closest to the object side in the second lens group, and
f1: focal length of the first lens group.

12. The optical system according to claim 1, wherein the optical system satisfies the following conditional expression:
0.005<DS/(−f11)<0.250
where
DS: distance on an optical axis from a lens surface closest to an image side in the first lens group to a lens surface closest to the object side in the second lens group, and
f11: focal length of a negative lens disposed closest to the object side in the first lens group.

13. The optical system according to claim 1, wherein the optical system satisfies the following conditional expression:
−1.000<(L1r2−L1r1)/(L1r2+L1r1)<−0.250
L1r1: radius of curvature of a lens surface of a negative lens disposed closest to the object side in the first lens group, the lens surface being on the object side, and
L1r2: radius of curvature of a lens surface of the negative lens disposed closest to the object side in the first lens group, the lens surface being on an image side.

14. The optical system according to claim 1, wherein the optical system satisfies the following conditional expression:
8.500<TL/f<21.000
where
TL: total length of the optical system, and
f: overall focal length of the optical system.

15. The optical system according to claim 1, wherein the optical system satisfies the following conditional expression:
0.800<BF/f<2.800
where
BF: back focus of the optical system, and
f: overall focal length of the optical system.

16. The optical system according to claim 1, wherein the optical system satisfies the following conditional expression:
5.000<ΣD1/f<13.000
where
ΣD1: distance on an optical axis from a lens surface closest to the object side to a lens surface closest to an image side in the first lens group, and
f: overall focal length of the optical system.

17. The optical system according to claim 1, wherein the optical system satisfies the following conditional expression:
2.800<ΣD2/f<8.200
where
ΣD2: distance on an optical axis from a lens surface closest to the object side to a lens surface closest to an image side in the second lens group, and
f: overall focal length of the optical system.

18. The optical system according to claim 1, wherein the optical system satisfies the following conditional expression:
1.000<(−f1ne)/f<3.000
where
f1ne: combined focal length of the negative lenses disposed on the object side of the positive lens in the first lens group, and
f: overall focal length of the optical system.

19. The optical system according to claim 1, wherein the optical system satisfies the following conditional expression:
1.200<f22/f<4.100
where
f22: focal length of a positive lens of a cemented lens closest to the object side among cemented lenses included in the second lens group, and
f: overall focal length of the optical system.

20. The optical system according to claim 1, wherein the optical system satisfies the following conditional expression:
−8.000<f2CL/(−f1)<90.000
where
f2CL: focal length of a cemented lens disposed closest to the object side among cemented lenses included in the second lens group, and
f: overall focal length of the optical system.

21. The optical system according to claim 1, wherein the optical system satisfies the following conditional expression:
0.500<(−f1ne)/θmax<4.500
where
f1ne: combined focal length of the negative lenses disposed on the object side of the positive lens in the first lens group, and
θmax: maximum value [radian] of the half angle of view of the optical system.

22. The optical system according to claim 1, wherein the optical system satisfies the following conditional expression:
32.000<νda<70.000
where
νda: average value of Abbe numbers of media of the negative lenses disposed on the object side of the positive lens in the first lens group at a d line.

23. The optical system according to claim 1, wherein the optical system satisfies the
0.250<(L3r1−L2r2)/(L3r1+L2r2)<1.500
where
L2r2: radius of curvature of a lens surface of a lens disposed second closest to the object side in the first lens group, the lens surface being on an image side, and
L3r1: radius of curvature of a lens surface of a lens disposed third closest to the object side in the first lens group, the lens surface being on the object side.

24. An optical apparatus comprising the optical system according to claim 1.

25. (canceled)

26. (canceled)

27. (canceled)

28. An optical apparatus comprising the optical system according to claim 2.

29. An optical apparatus comprising the optical system according to claim 3.

30. A method for manufacturing an optical system including, sequentially from an object side, a first lens group, an aperture stop, and a second lens group, the method for manufacturing the optical system comprising:
configuring the first lens group to include, sequentially from the object side, at least two negative lenses, a positive lens, and a back-side negative lens; and
further comprising one of the following features A, B, or C,
the feature A comprising
configuring the optical system to satisfy the following conditional expression:
90.00°<ωmax
where
ωmax: maximum value [°] of a half angle of view of the optical system,
the feature B comprising
configuring the optical system to satisfy the following conditional expression:
0.300<(−f1)/θmax<9.200
where
f1: focal length of the first lens group, and
θmax: maximum value [radian] of a half angle of view of the optical system, and
the feature C comprising
configuring the optical system to satisfy the following conditional expression:
0.280<D12/(−f1)<1.200
where
D12: distance on an optical axis between two negative lenses disposed closest to the object side in the first lens group, and
f1: focal length of the first lens group.
